(19) United States
(12) Patent Application Publication
(10) Pub. No.: US 2024/0397396 A1
(43) Pub. Date: Nov. 28, 2024

(54) SWITCHING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Fei LU, Dongguan (CN); Yali GUO, Dongguan (CN); Haorui YANG, Dongguan (CN)

(21) Appl. No.: 18/796,840

(22) Filed: Aug. 7, 2024

Related U.S. Application Data
(63) Continuation of application No. PCT/CN2022/075699, filed on Feb. 9, 2022.

(51) Int. Cl. H04W 36/00; H04W 88/04

(52) U.S. Cl. CPC H04W 36/033; H04W 36/0058; H04W 36/0085; H04W 88/04

(57) ABSTRACT

Provided is a switching method, which is applicable to a source network device. The method includes: transmitting first information to a target network device, wherein the first information is configured to determine a target relay terminal device; and receiving second information from the target network device and transmitting the second information to a remote terminal device, wherein the second information is configured to instruct the remote terminal device to switch to connect to the target network device via the target relay terminal device.

### CROSS-REFERENCE TO RELATED APPLICATION

This application is a continuation of International Application No. PCT/CN2022/075699, filed on Feb. 9, 2022, the disclosure of which is incorporated herein by reference in its entirety.

### TECHNICAL FIELD

The present disclosure relates to the field of communication, and in particular, relates to a switching method, a terminal device, a network device, a computer-readable storage medium, a computer program product, and a computer program.

### BACKGROUND

In the 3rd generation partnership project (3GPP), 5th generation mobile communication technology (5G) proximity-based service (ProSe) projects are used to design scenarios for proximity service communication. An important scenario in ProSe is UE-to-network (U2N) relay. In a candidate relay scenario, data is relayed for a U2N remote user equipment (UE) via a U2N relay UE, such that the U2N remote UE is capable of communicating with the network side via the relay UE. However, how to ensure the service continuity of the U2N remote UE becomes a problem to be solved.

### SUMMARY

Embodiments of the present disclosure provide a switching method, a terminal device, a network device, a computer-readable storage medium, a computer program product, and a computer program.

Some embodiments of the present disclosure provide a switching method. The method is applicable to a source network device, and includes:
transmitting first information to a target network device, wherein the first information is configured to determine a target relay terminal device; and
receiving second information from the target network device and transmitting the second information to a remote terminal device, wherein the second information is configured to instruct the remote terminal device to switch to connect to the target network device via the target relay terminal device.

Some embodiments of the present disclosure provide a network device, including a processor and a memory configured to store at least one computer program, wherein the processor, when loading and running the at least one computer program stored in the memory, is caused to perform:
transmitting first information to a target network device, wherein the first information is configured to determine a target relay terminal device; and
receiving second information from the target network device and transmitting the second information to a remote terminal device, wherein the second information is configured to instruct the remote terminal device to switch to connect to the target network device via the target relay terminal device.

Some embodiments of the present disclosure provide a terminal device. The terminal includes a processor and a memory configured to store at least one computer program, wherein the processor, when loading and running the at least one computer program stored in the memory, is caused to perform:
receiving second information from a source network device, wherein the second information is configured to instruct the remote terminal device to switch to connect to a target network device via a target relay terminal device.

### BRIEF DESCRIPTION OF DRAWINGS

FIG. 1 is a schematic diagram of an application scenario according to some embodiments of the present disclosure;

FIG. 2 is a schematic structural diagram of a 5G core network;

FIG. 3 is a schematic diagram of a system architecture of a U2N relay scenario;

FIG. 4 is a schematic diagram of a Model A discovery process for relay discovery in a U2N relay scenario;

FIG. 5 is a schematic diagram of a Model B discovery process for relay discovery in a U2N relay scenario;

FIG. 6 is a schematic flowchart I of a switching method according to some embodiments of the present disclosure;

FIG. 7 is a schematic flowchart II of a switching method according to some embodiments of the present disclosure;

FIG. 8 is a schematic flowchart III of a switching method according to some embodiments of the present disclosure;

FIG. 9 is a flowchart of an example of a switching method according to some embodiments of the present disclosure;

FIG. 10 is a flowchart of another example of a switching method according to some embodiments of the present disclosure;

FIG. 11 is a flowchart of yet another example of a switching method according to some embodiments of the present disclosure;

FIG. 12 is a flowchart of still yet another example of a switching method according to some embodiments of the present disclosure;

FIG. 13 is a flowchart of still yet another example of a switching method according to some embodiments of the present disclosure;

FIG. 14 is a schematic block diagram I of a source network device according to some embodiments of the present disclosure;

FIG. 15 is a schematic block diagram II of a source network device according to some embodiments of the present disclosure;

FIG. 16 is a schematic block diagram I of a target network device according to some embodiments of the present disclosure;

FIG. 17 is a schematic block diagram II of a target network device according to some embodiments of the present disclosure;

FIG. 18 is a schematic block diagram of a remote terminal device according to some other embodiments of the present disclosure;

FIG. 19 is a schematic block diagram of a communication device according to some embodiments of the present disclosure;

FIG. 20 is a schematic block diagram of a chip according to some embodiments of the present disclosure; and

FIG. 21 is a schematic block diagram of a communication system according to some embodiments of the present disclosure.

### DETAILED DESCRIPTION

The present disclosure is described in further detail with reference to the accompanying drawings, to clearly present the objects, technical solutions, and advantages of the present disclosure.

The technical solutions of the embodiments of the present disclosure may be applied to various communication systems, such as a global system of mobile communication (GSM), a code division multiple access (CDMA) system, a wideband code division multiple access (WCDMA) system, a general packet radio service (GPRS), a long-term evolution (LTE) system, an advanced long-term evolution (LTE-A) system, a new radio (NR) system, an evolutionary system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi), a 5th Generation (5G) system, or other communication systems.

Typically, traditional communication systems support a limited number of connections and are easy to implement. However, with the development of communication technologies, mobile communication systems will support not only traditional communication, but also, for example, device-to-device (D2D) communications, machine-to-machine (M2M) communications, machine-type communications (MTC), vehicle-to-vehicle (V2V) communications, or vehicle to everything (V2X) communications. The embodiments of the present disclosure may be applied to these communication systems as well.

In some embodiments, the communication system of the embodiments of the present disclosure is applied to a carrier aggregation (CA) scenario, a dual connectivity (DC) scenario, or a standalone (SA) deployment scenario.

In some embodiments, the communication system according to the embodiments of the present disclosure is applied to an unlicensed spectrum. The unlicensed spectrum is considered as a shared spectrum. Alternatively, the communication according to in the embodiments of the present disclosure is applied to a licensed spectrum. The licensed spectrum is considered as an unshared spectrum.

Some embodiments of the present disclosure describe various embodiments in conjunction with a network device and a terminal device. The terminal device is referred to as a user equipment (UE), an access terminal, a subscriber unit, a subscriber station, a mobile station, a mobile platform, a remote station, a remote terminal, a mobile device, a user terminal, a terminal, a wireless communication device, a user agent, or a subscriber device.

The terminal device is a station (ST) in a WLAN, a cellular telephone, a cordless telephone, a session initiation protocol (SIP) telephone, a wireless local loop (WLL) station, a personal digital assistant (PDA) device, a handheld device with a wireless communication function, a computing devices or other processing device connected to wireless modems, an in-vehicle device, a wearable device, a terminal device in a next-generation communication system such as the NR network, or a terminal device in a future evolved public land mobile network (PLMN).

In the embodiments of the present disclosure, the terminal device is deployed on the land, for example, indoors or outdoors, handheld, wearable, or in vehicles; or deployed on water (for example, on a ship); or the terminal device is deployed in air (for example, on an airplane, a balloon, or a satellite).

In some embodiments of the present disclosure, the terminal device is a mobile phone, a pad, a computer with a wireless transceiver function, a virtual reality (VR) terminal, an augmented reality (AR) terminal, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, or the like.

By way of example but not limitation, in the embodiments of the present disclosure, the terminal device is a wearable device. The wearable device is also referred to as a wearable smart device, which is a generic term for wearable devices such as glasses, gloves, watches, clothing, and shoes, which are intelligently designed and developed for daily wear by using wearable technologies. The wearable device is a portable device that is directly worn on the body or integrated into the clothing or accessories of the user. The wearable device is not only a hardware device, but also achieves powerful functions through software support as well as data interaction and cloud interaction. The wearable smart device in a broad sense includes devices such as smart watches or smart glasses that have full functionality and large size, and are capable of implementing all or part of functionality without depending on the smart phone, and devices such as various types of smart bracelets and smart jewelries for monitoring physical signs, which are dedicated to a specific type of application functions and need to be used in cooperation with other devices such as the smart phone.

In some embodiments of the present disclosure, the network device is a device for communicating with a mobile device. The network device is an access point (AP) in a WLAN, a base transceiver station (BTS) in a GSM or a CDMA, a NodeB (NB) in a WCDMA, or an evolutional Node B (eNB or eNodeB) in an LTE network, a relay station, an access point, an in-vehicle device, a wearable device, a network device (Gnb) in an NR network, a network device in a future evolved PLMN network, or a network device in an NTN network.

By way of example but not limitation, in the embodiments of the present disclosure, the network device has mobile characteristics. For example, the network device is a mobile device. Optionally, the network device is a satellite, a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. Optionally, the network device is a base station installed in locations such as land and water.

In some embodiments of the present disclosure, the network device provides services for cells, and the terminal device communicates with the network device over transmission resources (e.g., frequency domain resources or spectrum resources) used by the cell, which is a cell corresponding to the network device (e.g., a base station). The cell is a base station corresponding to a macro base station or a small cell. The small cell herein includes a metro cell, a micro cell, a pico cell, or a femto cell. These small cells are characterized by a small coverage area and low transmission power, which are suitable for providing high-speed data transmission services.

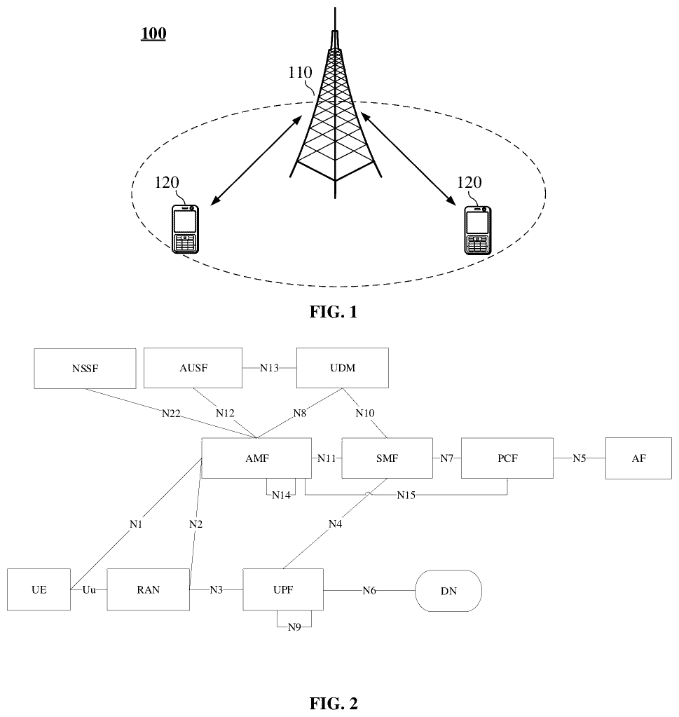

FIG. 1 exemplarily illustrates a communication system 100. The communication system includes a network device 110 and two terminal devices 120. In some embodiments, the communication system 100 includes a plurality of network devices 110, and a coverage area of each of the network devices 110 includes other numbers of terminal devices 120, which are not limited herein.

In some embodiments, the communication system 100 further includes other network entities such as a mobility management entity (MME) and an access and mobility management function (AMF), which are not limited herein.

The network device further includes an access network device and a core network device. That is, the wireless communication system also includes a plurality of core networks for communicating with the access network device. The access network device is an evolutional Node B (eNB or e-NodeB), a macro Node B, a micro Node B (also known as “small node B”), a micro-micro Node B, an AP, a transmission point (TP), or a next-generation Node B (gNodeB) in an LTE system, an NR system, or an authorized auxiliary access long-term evolution (LAA-LTE) system.

It should be understood that devices having communication functions in the networks/systems according to the embodiments of the present disclosure are referred to as communication devices. Using the communication system illustrated in FIG. 1 as an example, the communication device includes a network device and a terminal device having communication functions, and the network device and terminal device are specific devices according to the embodiments of the present disclosure, which are not repeated herein. The communication device further includes other devices in the communication system, such as a network controller or a mobility management entity, which are not limited herein.

For case of understanding of the embodiments of the present disclosure, the basic processes and the basic concepts involved in the embodiments of the present disclosure are briefly decried hereinafter. It should be understood that the basic processes and the basic concepts described hereinafter do not construe any limitation to the embodiments of the present disclosure.

In a 5G core network (5GC), each node is referred to as a network function (NF), and the architecture of the 5GC is illustrated in FIG. 2. The names and the functions of the individual NFs include: a network slice selection function (NSSF) mainly responsible for the management of information related to network slices, for example, selecting network slices for the terminal device; an authentication server function (AUSF) responsible for implementing the identity authentication function of user access; a unified data management (UDM) responsible for the management and storage of signing data and authentication data; an access and mobility management function responsible for mobility management, security anchor point, and security context management; a session management function (SMF), which is used to accomplish session management and UE IP address assignment and management; a policy control function (PCF) responsible for supporting the unified policy framework and provide policy rules; an application function (AF) for use in external application servers; a user plane function (UPF) responsible for complex user-plane processing, such as forwarding traffic and reporting traffic usage and quality of service (QOS) policy enforcement between an radio access network (RAN) and the Internet; and a data network (DN), i.e., an external data network of the 5GC (e.g., the Internet).

In addition, data transmission is achieved over corresponding interfaces between the nodes of the 5GC, between the UE and the nodes of the 5GC, between the UE and the RAN, and between the RAN and the nodes of the 5GC. For example, as shown in FIG. 2, data transmission is achieved between the AMF and the NSSF in the 5GC over an interface N22; data transmission is achieved between the AMF and the SMF over an interface N11; data transmission is achieved between the AMF and the AUSF over an N12; data transmission is achieved between the AMF and the UDM over an interface N8; data transmission is achieved between the SMF and the UPF by an interface N4; data transmission is achieved between the UPF and the RAN over an interface N3; data transmission is achieved between the UPF and the data network over an interface N6; data transmission is achieved between the UE and the AMF over an interface N1; data transmission is achieved between the UE and RAN over an interface Uu; data transmission is achieved between the RAN and the AMF over an interface N2; and data transmission is achieved between the RAN and UPF over an interface N3. It should be understood that only some of the interfaces between the nodes are described above, and other interfaces between the other nodes of the 5GC in FIG. 2 are not repeated herein.

With the continuous development of 5G applications, network-controlled interactive services (NCIS) are introduced as a new service form into the standard for related standardization services. The NCIS are mainly used for applications such as AR/VR and games, and imposes high requirements on service quality such as rate, delay, packet loss rate, high-speed coding and decoding. For example, for VR games, the rate needs to reach 10 Gbps, and the packet loss rate should not exceed 10E-4. A session established for the NCIS service is an NCIS session, and UEs in the same NCIS session are considered to form an NCIS group, e.g., teaming up in games.

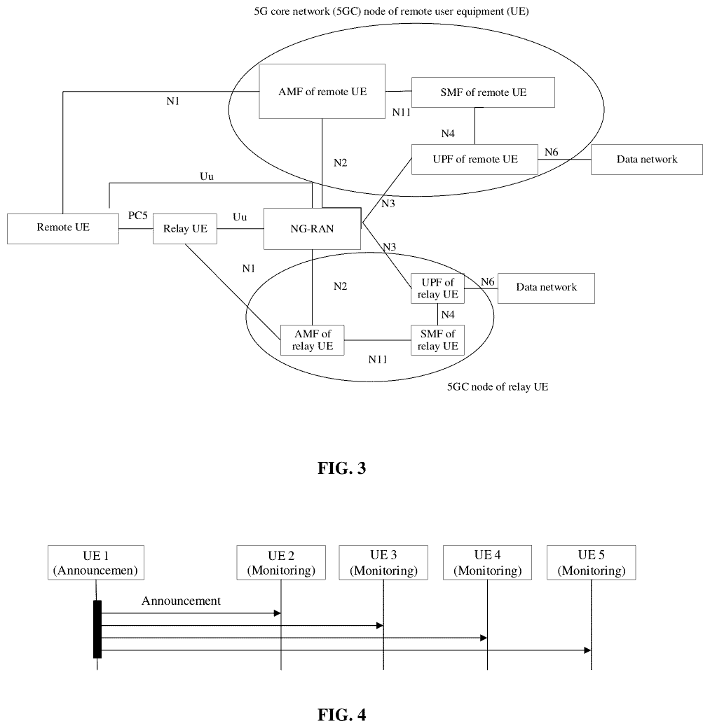

In the 3GPP R17, a 5G proximity service (ProSe) project is used for the scheme design of the proximity service communication. The ProSe includes the NCIS. One of the important scenarios of the ProSc is UE-to-network (U2N) relay. The U2N relay refers to relaying data for a U2N remote UE (hereinafter referred to as a remote UE) via a U2N relay UE (hereinafter referred to as a relay UE), such that the remote UE is capable of communicating with the network. The system architecture of the U2N relay scenario is shown in FIG. 3. A PC5 link is established between the remote UE and the relay UE, then the relay UE establishes a connection to a next-generation radio access network (NG-RAN), and data is transmitted over the RAN to 5GC nodes of the remote UE and 5GC nodes of the relay UE. The 5GC nodes of the remote UE include at least an AMF of the remote UE, an SMF of the remote UE, an UPF of the remote UE, and a data network that are illustrated in FIG. 3. The 5GC nodes of the relay UE include at least an AMF of the relay UE, an SMF of the relay UE, an UPF of the relay UE, and a data network that are illustrated in FIG. 3. Furthermore, the data transmission is achieved between the relay UE and the NG-RAN over the Uu interface, and the communication interfaces of the individual nodes of the 5GC are the same as those illustrated in FIG. 2, which are not repeated herein.

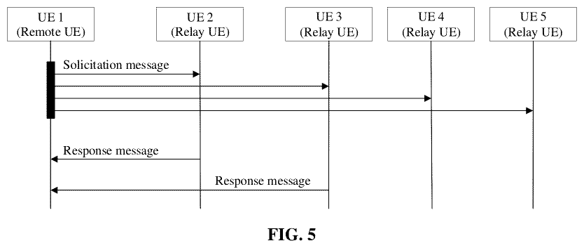

In the U2N relay scenario, for relay communication, the relay UE and the remote UE need to acquire mandatory configuration parameters prior to the relay communication. These configuration parameters are acquired from the PCF, from an application server, or are pre-configured on the terminal or in the SIM card. Prior to transmitting data, the remote UE needs to discover a suitable relay UE and establish a PC5 connection to the relay UE. Relay discovery includes a model A (FIG. 4) discovery process or a model B (FIG. 5) discovery process. As shown in FIG. 4, in the Model A discovery process, the relay UE (e.g., UE 1 in FIG. 4) transmits an announcement message which proactively broadcasts that the relay UE is capable of providing a relay service code (RSC) of relay services, and the remote UE (e.g., UE 2, UE 3, UE 4, and UE 5 in FIG. 4) is capable of selecting an appropriate relay UE based on the RSC contained in the received announcement message of each relay UE. The model B discovery process is shown in FIG. 5, where the remote UE (e.g., UE 1 in FIG. 5, which is referred to as the “discoverer”) transmits a solicitation message, which contains an RSC required by the remote UE itself, in a case where there are relay UEs (e.g., UE 2 and UE 3 in FIG. 5) around the remote UE that is capable of supporting the RSC, the relay UE transmits a response message to the remote UE, and the remote UE selects a suitable relay UE from the relay UEs that transmit the response message. In addition, in Layer 2 (L2) relay discovery-model A, the announcement message also needs to include a serving cell identifier (ID) of the relay UE; and in L2relay discovery-model B, the response message also needs to include a serving cell ID of the relay UE.

In the Release 17, for the U2N relay scenario, only intra-gNB (i.e., within the base station) switching is considered, so there is no situation where a source base station needs to select a destination base station (or a target base station) for switching. However, after the remote UE moves out of the coverage area of the source base station (e.g., source gNB), the inter-gNB (i.e., between base stations) switching scenario for the remote UE has not been studied. Therefore, there is a need to provide a way to enable inter-gNB switching in the U2N relay scenario to ensure service continuity of the remote UE and hence user experience.

It should be understood that the terms “system” and “network” are often used interchangeably herein. The term “and/or”, as used herein, is merely a way of describing the relationship of associated objects, indicating that three types of relationships may exist. For example, the phrase “A and/or B” means (A), (B), or (A and B). In addition, the symbol “/” in this document generally indicates an “or” relationship between associated objects.

It should be understood that the term “indicate” in the embodiments of the present disclosure may be a direct indication, an indirect indication, or an indication of an associated relationship. For example, the phrase “A indicating B” means that A indicates B directly, e.g., B may be acquired by A; or that A indicates B indirectly, e.g., A indicates C by which B may be acquired; or that an association is present between A and B.

In the description of the embodiments of the present disclosure, the term “correspond” may indicate a direct or indirect correspondence between two objects, an associated relationship between two objects, a relationship of indicating and being indicated, configuring and being configured, or the like.

For ease of understanding of the technical solutions according to the embodiments of the present disclosure, the relevant technologies of the embodiments of the present disclosure are described hereinafter, and the following relevant technologies may be combined with the technical solutions of the embodiments of the present disclosure in any combination as an optional option, and all of them shall fall within the protection scope of the embodiments of the present disclosure.

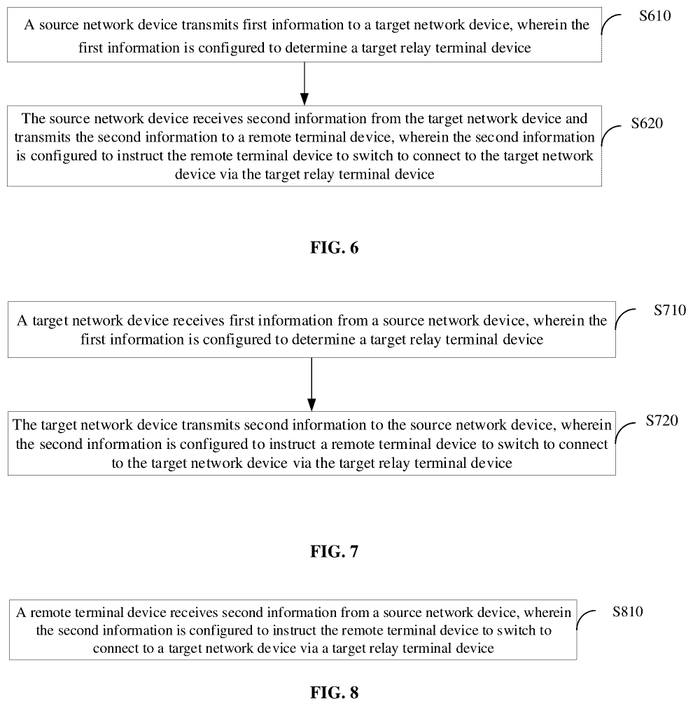

FIG. 6 is a schematic flowchart of a switching method according to some embodiments of the present disclosure. The method is applicable to the system shown in FIG. 1, but is not limited thereto. The method includes at least some of the following processes.

In S610, a source network device transmits first information to a target network device, wherein the first information is configured to determine a target relay terminal device.

In S620, the source network device receives second information from the target network device and transmits the second information to a remote terminal device, wherein the second information is configured to instruct the remote terminal device to switch to connect to the target network device via the target relay terminal device.

In the embodiments, the network device is a RAN device, the source network device refers to a source RAN device, and the target network device refers to a target RAN device. More specifically, the RAN device refers to a base station on the network side, such as a gNB, eNB, or the like.; the source network device is specifically a source base station; and the target network device is specifically a target base station. It should be understood that the source network device is different from the target network device.

The remote terminal device is referred to as a U2N remote terminal device. A service cell in which the remote terminal device is currently located is referred to as a source cell, and a network device corresponding to the source cell is the aforementioned source network device.

The target relay terminal device is referred to as a target U2N relay terminal device. The target relay terminal device is a relay terminal device within a target serving cell to which the remote terminal device is to be switched. A network device corresponding to the target serving cell is the aforementioned target network device.

Prior to S610, the method further includes: receiving, by the source network device, a measurement report from the remote terminal device.

Specifically, in some scenarios, the remote terminal device and the source network device are directly connected. That is, the data transmission is directly achieved between the remote terminal device and the source network device over a Uu interface. Accordingly, the source network device receiving the measurement report from the remote terminal device indicates that the source network device receives the measurement report directly from the remote terminal device over the Uu interface. The Uu interface is an air interface of a 5G system or an evolved universal terrestrial radio access network (E-UTRAN) system or an universal mobile telecommunications system (UMTS).

In other scenarios, the connection (or data transmission) is achieved between the remote terminal device and the source network device by a source relay terminal device. Accordingly, the source network device receiving the measurement report from the remote terminal device indicates that the source network device receives the measurement report transmitted, via the source relay terminal device, by the remote terminal device. The connection between the remote terminal device and the source relay terminal device is specifically a PC5 connection, and the data transmission is achieved between the source relay terminal device and the source network device over a Uu interface.

In either of the above scenarios, the measurement report includes at least one of an identifier of the candidate relay terminal device, a signal strength of the candidate relay terminal device, an identifier of a candidate cell to which the candidate relay terminal device belongs, or a signal strength of the candidate cell to which the candidate relay terminal device belongs.

The number of the candidate relay terminal devices in the measurement report is one or more, which is not limited herein. The identifier of the candidate relay terminal devices specifically refers to an identifier of each candidate relay terminal device in all candidate relay terminal devices. The identifier of any one of the candidate relay terminal devices is specifically an ID of the candidate relay terminal device. In some embodiments, the ID of the candidate relay terminal device is represented by any one of a temporary mobile subscriber identity (TMSI), an international mobile subscriber identity (IMSI), or an inactive radio network temporary identifier (I-RNTI).

The signal strength of the candidate relay terminal devices in the measurement report specifically refers to a signal strength of each candidate relay terminal device among all candidate relay terminal devices. The signal strength of any one candidate relay terminal device specifically refers to a received signal strength of the candidate relay terminal device measured by the remote terminal device.

The identifier of the candidate cell to which the candidate relay terminal device belongs in the measurement report specifically refers to an identifier of the candidate cell to which each candidate relay terminal device belongs among all the candidate relay terminal devices, for example, expressed as the ID of the candidate cell to which each candidate relay terminal device belongs.

The signal strength of the candidate cell to which the candidate relay terminal device belongs in the measurement report is acquired by the remote terminal device performing a legacy Uu interface measurement.

It should be noted that all of the above content are included in the measurement report. That is, one measurement report includes the identifier of the candidate relay terminal device, the signal strength of the candidate relay terminal device, the identifier of the candidate cell to which the candidate relay terminal device belongs, and the signal strength of the candidate cell to which the candidate relay terminal device belongs. Alternatively, the measurement report includes some of the above content. For example, one measurement report includes the identifier of the candidate relay terminal device and the identifier of the candidate cell to which the candidate relay terminal device belongs; or, one measurement report includes the identifier of the candidate relay terminal device and the signal strength of the candidate relay terminal device. What the measurement report contains is not exhaustively listed herein.

Upon receiving the measurement report, the source network device processes the measurement report in the following three approaches.

### First Approach

The source network device determines the target serving cell from candidate cells based on the measurement report.

The source network device determines candidate relay terminal devices within the target serving cell based on the measurement report, and determines the target relay terminal device that satisfies a predetermined condition from the candidate relay terminal devices within the target serving cell; wherein the predetermined condition includes at least one of a minimum load or a maximum signal strength.

The source network device determining the target serving cell from the candidate cells based on the measurement report includes: extracting signal strengths, from the measurement report, of the candidate cells to which the candidate relay terminal device belongs, and selecting a candidate cell with the greatest signal strength from the candidate cells as the target serving cell.

The signal strength of the candidate cell includes a reference signal received power (RSRP) measurement result and/or a reference signal received quality (RSRQ) measurement result. Accordingly, selecting the candidate cell with the greatest signal strength from the candidate cells as the target serving cell includes: selecting a candidate cell with the greatest RSRP measurement result from the candidate cells as the target serving cell, selecting a candidate cell with the greatest RSRQ measurement result from the candidate cells as the target serving cell, or selecting a candidate cell with the greatest RSRP measurement result and the greatest RSRQ measurement result from the candidate cells as the target serving cell.

The process that the source network device determines the candidate relay terminal devices within the target serving cell based on the measurement report, and determines the target relay terminal device that satisfies the predetermined condition from the candidate relay terminal devices within the target serving cell includes one of the following operations:
determining candidate relay terminal devices within the target serving cell from all candidate relay terminal devices included in the measurement report, and selecting a candidate relay terminal device with the smallest load from the candidate relay terminal devices within the target serving cell as the target relay terminal device; wherein in a case where a plurality of candidate relay terminal devices with the smallest load exist among the candidate relay terminal devices within the target serving cell, then any one of the plurality of candidate relay terminal devices with the smallest load is randomly selected as the target relay terminal device;
determining candidate relay terminal devices within the target serving cell from all candidate relay terminal devices included in the measurement report, and selecting, based on the measurement report, a candidate relay terminal device with the greatest signal strength from the candidate relay terminal devices within the target serving cell as the target relay terminal device; wherein in a case where a plurality of candidate relay terminal devices with the greatest signal strength exist among the candidate relay terminal devices within the target serving cell, then any one of the plurality of the candidate relay terminal devices with the greatest signal strength is randomly selected as the target relay terminal device;
determining candidate relay terminal devices within the target serving cell from all candidate relay terminal devices included in the measurement report, selecting, based on the measurement report, N candidate relay terminal devices with the smallest loads from the candidate relay terminal devices within the target serving cell, and selecting one candidate relay terminal device with the greatest signal strength from the N candidate relay terminal devices as the target relay terminal device, wherein N is an integer greater than or equal to 1; wherein it is also noted that in a case where a plurality of candidate relay terminal devices with the greatest signal strength exist among the N candidate relay terminal devices, any one of the plurality of candidate relay terminal devices with the greatest signal strength is randomly selected as the target relay terminal device; or
determining candidate relay terminal devices within the target serving cell from all candidate relay terminal devices included in the measurement report, selecting M candidate relay terminal devices with the greatest signal strength from the candidate relay terminal devices within the target serving cell based on the measurement report, and selecting one candidate relay terminal device with the smallest load from the M candidate relay terminal devices as the target relay terminal device, wherein M is an integer greater than or equal to 1; wherein it is also noted that in a case where a plurality of candidate relay terminal devices with the smallest load exist among the M candidate relay terminal devices, any one of the plurality of candidate relay terminal devices with the smallest load is randomly selected as the target relay terminal device.

It should be understood that a plurality of candidate relay terminal devices are included in the measurement report, wherein different candidate relay terminal devices belong to different candidate cells or belong to the same candidate cell. The candidate relay terminal devices within the target serving cell are candidate relay terminal devices located within the target serving cell among all candidate relay terminal devices in the measurement report. For example, there are 10 candidate relay terminal devices included in the measurement report, denoted as candidate relay terminal device 1 to candidate relay terminal device 10; wherein the candidate relay terminal device 1, the candidate relay terminal device 2, and the candidate relay terminal device 3 are candidate relay terminal devices within a candidate cell 1, the candidate relay terminal device 4 and the candidate relay terminal device 5 are candidate relay terminal devices within a candidate cell 2, and the candidate relay terminal device 6 to the candidate relay terminal device 10 are candidate relay terminal devices within a candidate cell 3. In a case where the target serving cell is the candidate cell 2, the candidate relay terminal devices within the target serving cell are the candidate relay terminal device 4 and the candidate relay terminal device 5 described above.

The source network device generates the first information based on the selected target serving cell acquired and the target relay terminal device within the target serving cell. The first information includes at least one of an identifier of the target serving cell or an identifier of the target relay terminal device within the target serving cell.

In some embodiments, the first information includes the identifier of the target serving cell and the identifier of the target relay terminal device within the target serving cell. That is, the first information includes the identifier of the aforementioned target serving cell and an identifier of the target relay terminal device within the target serving cell.

In some other embodiments, the first information at least includes the identifier of the target relay terminal device within the target serving cell. That is, the first information includes only the identifier of the target relay terminal device.

### Second Approach

The source network device determines the target serving cell from candidate cells based on the measurement report; and the source network device determines candidate relay terminal devices within the target serving cell based on the measurement report.

Specifically, the source network device determining the target serving cell from the candidate cells based on the measurement report includes: selecting, based on signal strengths of the candidate cells to which the candidate relay terminal devices belong included in the measurement report, a candidate cell with the greatest signal strength from the candidate cells as the target serving cell.

The signal strength of the candidate cell includes an RSRP measurement result and/or an RSRQ measurement result. Accordingly, selecting the candidate cell with the greatest signal strength from the candidate cells as the target serving cell includes: selecting a candidate cell with the greatest RSRP measurement result from the candidate cells as the target serving cell, selecting a candidate cell with the greatest RSRQ measurement result from the candidate cells as the target serving cell, or selecting a candidate cell with the greatest RSRP measurement result and the largest RSRQ measurement from the candidate cells as the target serving cell.

The source network device determining, based on the measurement report, the candidate relay terminal devices within the target serving cell includes: determining the candidate relay terminal devices within the target serving cell from all candidate relay terminal devices included in the measurement report,

The measurement report contains a plurality of candidate relay terminal devices, wherein the candidate cells to which different candidate relay terminal devices belong are the same or different. The candidate relay terminal devices within the target serving cell are candidate relay terminal devices located within the target serving cell among all candidate relay terminal devices in the measurement report. For example, there are 10 candidate relay terminal devices included in the measurement report, denoted as candidate relay terminal device 1 to candidate relay terminal device 10; wherein the candidate relay terminal device 1, the candidate relay terminal device 2, and the candidate relay terminal device 3 are candidate relay terminal devices within a candidate cell 1, the candidate relay terminal device 4 and the candidate relay terminal device 5 are candidate relay terminal devices within a candidate cell 2, and the candidate relay terminal device 6 to the candidate relay terminal device 10 are candidate relay terminal devices within a candidate cell 3. In a case where the target serving cell is the candidate cell 1, the candidate relay terminal devices within the target serving cell are the aforementioned candidate relay terminal device 1, candidate relay terminal device 2, and candidate relay terminal device 3.

The source network device generates the first information based on the selected target serving cell and the target relay terminal device within the target serving cell. The first information includes at least one of an identifier of the target serving cell, an identifier of the candidate relay terminal device within the target serving cell, or a signal strength of the candidate relay terminal device within the target serving cell.

In some embodiments, the first information includes the identifier of the target serving cell, the identifier of the candidate relay terminal device within the target serving cell, and the signal strength of the candidate relay terminal device within the target serving cell.

In some other embodiments, the first information includes at least the identifier of the candidate relay terminal device within the target serving cell. That is, the first information includes only the identifier of the candidate relay terminal device.

In some other embodiments, the first information includes the identifier of the candidate relay terminal device within the target serving cell and the signal strength of the candidate relay terminal device within the target serving cell. That is, the first information includes only the identifier and the signal strength of the candidate relay terminal device.

### Third Approach

The source network device determines, based on the measurement report, a target network device where a target serving cell is located from candidate cells; and the source network device determines, based on the measurement report, candidate relay terminal devices within the target network device.

Specifically, the source network device determining, based on the measurement report, the target network device where the target serving cell is located from the candidate cells includes: selecting, based on signal strengths of the candidate cells to which the candidate relay terminal devices included in the measurement report belong, a candidate cell with the greatest signal strength from the candidate cells as the target serving cell, and determining a network device where the target serving cell is located as the target network device.

The process that the source network device selects the candidate cell with the greatest signal strength from the candidate cells as the target serving cell based on the signal strengths of the candidate cells to which the candidate relay terminal included in the measurement report devices belong is the same as that in the first or second way described above, which is not repeated herein.

The source network device obtaining the candidate relay terminal devices within the target network device based on the measurement report includes: determining all service cells within the target network device, and determining, from all candidate relay terminal devices included in the measurement report, the candidate relay terminal devices within all service cells of the target network device.

The measurement report contains a plurality of candidate relay terminal devices, wherein the candidate cells to which different candidate relay terminal devices belong are the same or different. The candidate relay terminal devices within the target serving cell are candidate relay terminal devices located within the target serving cell among all candidate relay terminal devices in the measurement report. For example, there are 10 candidate relay terminal devices included in the measurement report, denoted as candidate relay terminal device 1 to candidate relay terminal device 10; wherein the candidate relay terminal device 1, the candidate relay terminal device 2, and the candidate relay terminal device 3 are candidate relay terminal devices within a candidate cell 1, the candidate relay terminal device 4 and the candidate relay terminal device 5 are candidate relay terminal devices within a candidate cell 2, and the candidate relay terminal device 6 to the candidate relay terminal device 10 are candidate relay terminal devices within a candidate cell 3. In a case where the target serving cell is candidate cell 1, the candidate cell belongs to a target network device A, and the target network device A contains the candidate cell 1 and candidate cell 2, thus the candidate relay terminal devices in all service cells of the target network device A include candidate relay terminal devices in the candidate cell 1 and candidate cell 2, i.e., the aforementioned candidate relay terminal device 1, candidate relay terminal device 2, candidate relay terminal device 3, candidate relay terminal device 4, and candidate relay terminal device 5.

The source network device generates the first information based on the selected target serving cell and the target relay terminal device within the target serving cell. The first information includes at least one of: an identifier of the target network device, an identifier of the candidate relay terminal device within the target network device, or a signal strength of the candidate relay terminal device within the target network device.

In some embodiments, the first information includes the identifier of the target network device, the signal strength of the candidate relay terminal device within the target network device, and the identifier of the candidate relay terminal device within the target network device.

In some other embodiments, the first information includes at least the identifier of the candidate relay terminal device within the target network device. That is, the first information includes only the identifier of the candidate relay terminal device.

In some other embodiments, the first information includes the identifier of the candidate relay terminal device within the target network device and the signal strength of the candidate relay terminal device within the target network device. That is, the first information includes only the identifier of the candidate relay terminal device and its signal strength.

In a case where the source network device generates the first information based on the foregoing processing, S610 is performed. That is, the source network device transmits the first information to the target network device.

Specifically, in one scenario, the source network device is directly connected to the target network device over an Xn interface. Accordingly, the source network device transmitting the first information to the target network device includes: transmitting the first information directly to the target network device over the Xn interface between the source network device and the target network device. The first information is carried by a handover request message. The Xn interface is a network interface between NG-RAN nodes (such as gNBs or ng-eNBs).

It should be understood that the handover request message carries other contents in addition to the first information, which includes, by way of example: a handover cause, UE context information, RRC context information, and the like, without exhausting the list herein.

In another scenario, the data transmission is achieved between the source network device and the target network device by a core network device. Accordingly, the source network device transmitting the first information to the target network device includes: transmitting the first information to the target network device via the core network device.

The source network device transmitting the first information to the target network device via the core network device specifically means that the source network device transmits a handover required message carrying the first information to a source AMF, the source AMF transmits a Namf_Communication_CreateUEContextRequest carrying the first information to a target AMF, and the target AMF transmits a handover request message carrying the first information to the target network device.

Prior to the process that the target AMF transmits the handover request message carrying this first information to the target network device, the processing of the core network device further includes the following operations: the target AMF transmits a Nsmf_PDU Session_UpdateSMContext Request to an SMF; the SMF selects a UPF (UPS selection); the SMF transmits an N4 session modification request to a PDU session anchor (PSA) UPF; the PSA UPF transmits an N4 session modification response to the SMF; the SMF transmits an N4 session establishment request to a target UPF; the target UPF transmits an N4 session establishment response to the SMF; the SMF transmits a Nsmf_PDU Session_UpdateSMContext Response to a target AMF; and a PDU handover response supervision is performed between the target AMF and the SMF.

The handover required message carries other content in addition to the first information described above, for example, a target tracking area identity (TAI), a handover cause, UE context information, RRC context information, and the like, which is not exhaustively listed herein.

In a case where the source network device transmits the first information to the target network device, S620 is performed. That is, the source network device receives the second information from the target network device, and transmits the second information to the remote terminal device.

The description of the source network device receiving the second information from the target network device is given hereinafter.

In one scenario, the source network device and the target network device are directly connected to each other over an Xn interface. Accordingly, the source network device receiving the second information from the target network device includes: receiving the second information from the target network device over the Xn interface. The second information is carried by a handover required confirmation message.

The Xn interface is a network interface between NG-RAN nodes, such as gNBs or ng-eNBs.

In another scenario, the data transmission is achieved between the source network device and the target network device by a core network device. Accordingly, the source network device receiving the second information from the target network device includes: receiving the second information from the target network device via the core network device.

The source network device receiving the second information from the target network device via the core network device specifically includes the following operations.

The target network device transmits a handover request acknowledge message carrying the second information to a target AMF; the target AMF transmits a Namf_Communication_CreateUEContext Response carrying the second information to a source AMF; and the source AMF transmits a handover command carrying the second information to the source network device.

Before the target AMF transmits the Namf_Communication_CreateUEContext Response carrying the second information to the source AMF, the specific processing at the core network device further includes: the target AMF transmits a Nsmf_ PDUSession_UpdateSMContext Request to an SMF; the SMF transmits an N4 session modification request to a target UPF; the target UPF transmits an N4 session modification response to the SMF; the SMF transmits the N4 session modification request to a source UPF; the source UPF transmits the N4 session modification response; and the SMF transmits a Nsmf_PDUSession_UpdateSMContext Response to the target AMF.

The description of the source network device transmitting the second information to the remote terminal device is given hereinafter.

In scenario 1, the remote terminal device and the source network device are directly connected. That is, the data transmission is directly performed between the remote terminal device and the source network device over a Uu interface.

Transmitting the second information to the remote terminal device includes the source network device transmits the second information to the remote terminal device over the Uu interface, wherein the second information is carried by a radio resource control (RRC) reconfiguration message.

In a case where the second information is transmitted to the remote terminal device, the source network device releases the connection to the remote terminal device.

In scenario 2, the connection (or data transmission) between the remote terminal device and the source network device is performed by a source relay terminal device. The connection between the remote terminal device and the source relay terminal device is specifically a PC5 connection; and the data transmission is achieved between the source relay terminal device and the source network device over a Uu interface.

Transmitting the second information to the remote terminal device specifically includes: transmitting the second information to the remote terminal device via the source relay terminal device. The second information is carried by a RRC reconfiguration message.

In scenario 2, in a case where the source network device transmits the second information to the remote terminal device via the source relay terminal device, the process further includes: transmitting, by the source network device, third information to the source relay terminal device, wherein the third information is configured to instruct the source relay terminal device to release the connection to the remote terminal device. Accordingly, the source relay terminal device releases the connection to the remote terminal device upon receiving the third information. The third information is carried by a RRC reconfiguration message. In a case where the third information is transmitted to the remote terminal device, the source network device releases the connection to the remote terminal device.

In the scenarios 1 and 2, the second information includes an identifier of the target relay terminal device. Additionally, the second information further includes an identifier of the target serving cell. The second information is a handover command, or the second information is specifically a handover command carried by the RRC reconfiguration message.

In the above-described scheme, the first information for determining the target relay terminal device is transmitted by the source network device to the target network device, and in a case where the source network device receives the second information transmitted from the target network device, the source network device is capable of transmitting the second information to the remote terminal device, such that the remote terminal device switches to establish a connection to the target network device via the target relay terminal device based on the second information. In this way, the switching of network devices is achieved by the remote terminal device, and the problem of the loss of data packets caused by the remote terminal device not being able to establish a connection to the target network device via the target relay terminal device as soon as possible during the switching of network devices is avoided, such that the service continuity of the remote terminal device is ensured.

FIG. 7 is a schematic flowchart of a switching method according to some embodiments of a second aspect of the present disclosure. The method is applicable to the system shown in FIG. 1, which is not limited thereto. The method includes at least some of the following processes.

In S710, a target network device receives first information from a source network device, wherein the first information is configured to determine a target relay terminal device.

In S720, the target network device transmits second information to the source network device, wherein the second information is configured to instruct a remote terminal device to switch to connect to the target network device via the target relay terminal device.

In the embodiments, the network device is a RAN device, the source network device refers to a source RAN device, and the target network device refers to a target RAN device. More specifically, the RAN device refers to a base station on the network side, such as a gNB, eNB, or the like; the source network device is specifically a source base station; and the target network device is specifically a target base station. It should be understood that the source network device is different from the target network device.

The remote terminal device is referred to as a U2N remote terminal device. A service cell in which the remote terminal device is currently located is referred to as a source cell, and a network device corresponding to the source cell is the aforementioned source network device.

The target relay terminal device is referred to as a target U2N relay terminal device. The target relay terminal device is a relay terminal device within a target serving cell to which the remote terminal device switches. A network device corresponding to the target serving cell is the aforementioned target network device.

The process that the target network device receives the first information from the source network device in S710 involves the following scenarios.

In one scenario, the target network device and the source network device are directly connected to each other over an Xn interface. Accordingly, the target network device receiving the first information from the source network device includes the target network device receives, over the Xn interface, the first information from the source network device. The Xn interface is a network interface between NG-RAN nodes, such as gNBs or ng-eNBs.

The first information is carried by a handover request information. It should be understood that the handover request message carries other contents in addition to the first information, which includes, by way of example: a handover cause, UE context information, RRC context information, and the like, which are not exhaustive herein.

In another scenario, the data transmission is achieved between the target network device and the source network device by a core network device. Accordingly, the target network device receiving the first information from the source network device includes: receiving the first information from the source network device via the core network device.

The target network device receiving the first information from the source network device via the core network device specifically indicates that the source network device transmits a handover required message carrying the first information to a source AMF; the source AMF transmits a Namf_Communication_CreateUEContext request carrying the first information to a target AMF; and the target network device receives a handover request message carrying the first information transmitted from the target AMF.

Prior to the process that the target network device receives the handover request message carrying the first information transmitted by the target AMF, the processing of the core network device further includes the following operations: the target AMF transmits a Nsmf_PDU Session_UpdateSMContext Request to an SMF; the SMF selects a UPF (UPF Selection); the SMF transmits an N4 session modification request to a PDU session anchor (PSA) UPF; the PSA UPF transmits an N4 session modification response to the SMF; the SMF transmits an N4 session establishment request to a target UPF; the target UPF transmits an N4 session establishment response to the SMF; the SMF transmits a Nsmf_PDU Session_UpdateSMContext response; and a PDU handover response supervision is performed between the target AMF and the SMF.

The handover required message carries other contents in addition to the above first information, and, for example, includes a target tracking area identity (TAI), a handover cause, UE context information, RRC context information, and the like. No exhaustive list is given here.

Upon S710, i.e., upon receiving the first information from the source network device, the target network device determines a target relay terminal device based on the first information. Specifically, in the case of different contents contained in the first information, the target network device determines the target relay terminal device based on the first information in different approaches.

### A First Approach

The first information includes at least one of an identifier of a target serving cell or an identifier of the target relay terminal device within the target serving cell.

In some embodiments, the first information includes the identifier of the target serving cell and the identifier of the target relay terminal device within the target serving cell.

In some other embodiments, the first information at least includes the identifier of the target relay terminal device within the target serving cell. That is, the first information includes only the identifier of the target relay terminal device.

The target network device determines the target relay terminal device based on the first information. Specifically, the target network device directly acquires the identifier of the target relay terminal device from the first information and determines the target relay terminal device based on the identifier of the target relay terminal device.

Further, in a case where the first information also includes the identifier of the target serving cell, the target network device determines the target serving cell to which the target relay terminal device belongs based on the identifier of the target serving cell included in the first information.

In a case where the first information does not include the identifier of the target serving cell, the target network device determines the target serving cell to which the target relay terminal device belongs based on the identifier of the target relay terminal device.

### Second Approach

The first information includes at least one of: an identifier of a target serving cell, an identifier of the candidate relay terminal device within the target serving cell, or a signal strength of the candidate relay terminal device within the target serving cell.

In some embodiments, the first information includes the identifier of the target serving cell, the identifier of the candidate relay terminal device within the target serving cell, and the signal strength of the candidate relay terminal device within the target serving cell.

In some other embodiments, the first information includes at least the identifier of the candidate relay terminal device within the target serving cell. That is, the first information includes only the identifier of the candidate relay terminal device.

In some other embodiments, the first information includes the identifier of the candidate relay terminal device within the target serving cell and the signal strength of the candidate relay terminal device within the target serving cell. That is, the first information includes only the identifier and signal strength of the candidate relay terminal device.

The target network device determines the candidate relay terminal devices within the target serving cell based on the first information, and determines the target relay terminal device satisfying a predetermined condition from the candidate relay terminal devices within the target serving cell. The predetermined condition includes at least one of a minimum load or a maximum signal strength.

The target network device obtaining the candidate relay terminal devices within the target serving cell based on the first information includes: determining the target serving cell based on the identifier of the target serving cell included in the first information, and obtaining the candidate relay terminal devices based on the identifiers of the candidate relay terminal devices within the target serving cell included in the first information.

The process of determining the target relay terminal device satisfying the predetermined condition from the candidate relay terminal devices within the target serving cell includes one of the following operations:
selecting a candidate relay terminal device with the smallest load as the target relay terminal device from the candidate relay terminal devices within the target serving cell; wherein in a case where a plurality of candidate relay terminal devices with the smallest load exist among the candidate relay terminal devices in the target serving cell, any one of the plurality of candidate relay terminal devices with the smallest load is randomly selected as the target relay terminal device;
selecting a candidate relay terminal device with the greatest signal strength as the target relay terminal device from the candidate relay terminal devices within the target serving cell; wherein in a case where a plurality of candidate relay terminal devices with the greatest signal strength exist among the candidate relay terminal devices in the target serving cell, any one of the plurality of candidate relay terminal devices with the greatest signal strength is randomly selected as the target relay terminal device;
selecting L candidate relay terminal devices with the smallest load from the candidate relay terminal devices within the target serving cell, and selecting one candidate relay terminal device with the greatest signal strength from the L candidate relay terminal devices as the target relay terminal device, wherein L is an integer greater than or equal to 1; wherein it is also noted that in a case where a plurality of candidate relay terminal devices with the greatest signal strength exist among the L candidate relay terminal devices, then any one of the plurality of candidate relay terminal devices with the greatest signal strength is randomly selected as the target relay terminal device; or
selecting K candidate relay terminal devices with the greatest signal strength from the candidate relay terminal devices within the target serving cell, and selecting one candidate relay terminal device with the smallest load from the K candidate relay terminal devices as the target relay terminal device, wherein K is an integer greater than or equal to 1; wherein it is noted that in a case where a plurality of candidate relay terminal devices with the smallest load exist among the K candidate relay terminal devices, then any one of the plurality of candidate relay terminal devices with the smallest load is randomly selected as the target relay terminal device.

### Third Approach

The first information includes at least one of an identifier of a target network device, an identifier of a candidate relay terminal device within the target network device, or a signal strength of the candidate relay terminal device within the target network device.

In some embodiments, the first information includes the identifier of the target network device, the signal strength of the candidate relay terminal device within the target network device, and the identifier of the candidate relay terminal device within the target network device.

In some other embodiments, the first information includes at least the identifier of the candidate relay terminal device within the target network device. That is, the first information includes only the identifier of the candidate relay terminal device.

In some other embodiments, the first information includes the identifier of the candidate relay terminal device within the target network device and the signal strength of the candidate relay terminal device within the target network device. That is, the first information includes only the identifier and the signal strength of the candidate relay terminal device.

The target network device determines the candidate relay terminal devices within the target network device based on the first information and determines the target relay terminal device that satisfies a predetermined condition from the candidate relay terminal devices within the target network device. The predetermined condition includes at least one of a minimum load or a maximum signal strength.

The target network device obtaining the candidate relay terminal devices within the target network device based on the first information includes: determining the target network device based on the identifier of the target network device contained in the first information, and obtaining the candidate relay terminal devices based on the identifiers of the candidate relay terminal devices within the target network device contained in the first information.

The process of determining the target relay terminal device satisfying the predetermined condition from the candidate relay terminal devices within the target network device includes one of the following operations:
selecting, from the candidate relay terminal devices within the target network device, a candidate relay terminal device with the smallest load as the target relay terminal device; herein, in a case where a plurality of candidate relay terminal devices with the smallest load exist among the candidate relay terminal devices within the target network device, any one of the plurality of candidate relay terminal devices with the smallest load is randomly selected the target relay terminal device;
selecting a candidate relay terminal device with the greatest signal strength as the target relay terminal device from the candidate relay terminal devices within the target network device; wherein in a case where a plurality of candidate relay terminal devices with the greatest signal strength exist among the candidate relay terminal devices within the target network device, any one of the plurality of candidate relay terminal devices with the greatest signal strength is randomly selected as the target relay terminal device;
selecting L candidate relay terminal devices with the smallest load from the candidate relay terminal devices within the target network device, and selecting one candidate relay terminal device with the greatest signal strength from the L candidate relay terminal devices as the target relay terminal device, wherein L is an integer greater than or equal to 1; herein, it should be also noted that in a case where a plurality of candidate relay terminal devices with the greatest signal strength exist among the L candidate relay terminal devices, then any one of the plurality of candidate relay terminal devices with the greatest signal strength is randomly selected as the target relay terminal device; or
selecting K candidate relay terminal devices with the greatest signal strength from the candidate relay terminal devices within the target network device, and selecting one candidate relay terminal device with the smallest load from the K candidate relay terminal devices as the target relay terminal device, wherein K is an integer greater than or equal to 1; wherein it should be also noted that in a case where a plurality of candidate relay terminal devices with the smallest load exist among the K candidate relay terminal devices, then any one of the plurality of candidate relay terminal devices with the smallest load is randomly selected as the target relay terminal device.

Further, in a case where the target network device determines the target relay terminal device, a cell in which the target relay terminal device is located is determined as the target serving cell.

Based on the foregoing processing, the target network device is capable of determining the target relay terminal device and the target serving cell; and further, the target terminal device is capable of generating the second information. The second information includes an identifier of the target relay terminal device; furthermore, the second information includes an identifier of the target serving cell. It should be understood that before the target network device generates the second information, the following processing is performed based on the target relay terminal device, such as: performing target serving cell resource admission and allocating air resources and bearer resources for services for the access of the target relay terminal device, which are not exhaustively enumerated herein.

Upon completion of the foregoing processing, S720 is performed. That is, the target network device transmits the second information to the source network device. Specifically, the description is given hereinafter.

In one scenario, the target network device and the source network device are directly connected to each other over an Xn interface. Accordingly, transmitting the second information from the target network device to the source network device includes: transmitting the second information, which is carried by a handover required confirmation message, to the source network device over the Xn interface. The Xn interface is a network interface between NG-RAN nodes, such as gNBs or ng-eNBs.

In another scenario, the data transmission is achieved between the target network device and the source network device by a core network device. Accordingly, transmitting the second information from the target network device to the source network device includes: transmitting the second information to the target network device via the core network device.

The target network device transmitting the second information to the target network device via the core network device includes the following operations: the target network device transmits a handover request acknowledge message carrying the second information to a target AMF; the target AMF transmits a Namf_Communication_CreateUEContext Response to a source AMF; and the source AMF transmits a handover command carrying the second information to the source network device.

Before the target AMF transmits the Namf_Communication_CreateUEContext Response carrying the second information to the source AMF, the specific processing at the core network device further includes the following operations: the target AMF transmits to a Nsmf_PDUSession_UpdateSMContext Request to the SMF; the SMF transmits an N4 session modification request to a target UPF; the target UPF transmits an N4 session modification response to the SMF; the SMF transmits the N4 session modification request to a source UPF; the source UPF transmits the N4 session modification response to the SMF; and the SMF transmits a Nsmf_PDU Session_UpdateSMContext Response to the target AMF.

In some embodiments, the method further includes: transmitting, by the target network device, fourth information to the target relay terminal device. The fourth information is configured to instruct the target relay terminal device to establish a connection to the remote terminal device. The fourth information includes an identifier of the target relay terminal device, and the fourth information is carried by an RRC reconfiguration message.

It should be noted that the process that the target network device transmits the fourth information to the target relay terminal device is performed in a case where the target network device generates the second information and prior to transmitting the second information to the source network device; or alternatively performed in a case where the target network device transmits the second information to the source network device, which is not limited herein.

Upon receiving the fourth information, the target relay terminal device determines to establish a connection to the remote terminal device based on the fourth information.

Further, the method includes: receiving, by the target network device receives fifth information from the remote terminal device via the target relay terminal device. The fifth information indicates that the remote terminal device completes the path switching. The fifth information is carried by an RRC reconfiguration completion message.

In a case where the target network device receives the fifth information, it is determined that the remote terminal device has established a connection to the target relay terminal device, and then uplink and/or downlink data transmission can be performed between the remote terminal device and the target relay terminal device.

The source network device transmits the first information for determining the target relay terminal device to the target network device, and the target network device transmits the second information to the source network device, such that the source network device is capable of transmitting the second information to the remote terminal device, and thus the remote terminal device is capable of switching, based on the second information, to establish a connection to the target network device via the target relay terminal device. In this way, the switching of network devices is achieved by the remote terminal device, and the loss of data packets caused by the remote terminal device failing to establish a connection to the target network device via the target relay terminal device as soon as possible during the switching of network devices is avoided, such that the service continuity of the remote terminal device is ensured.

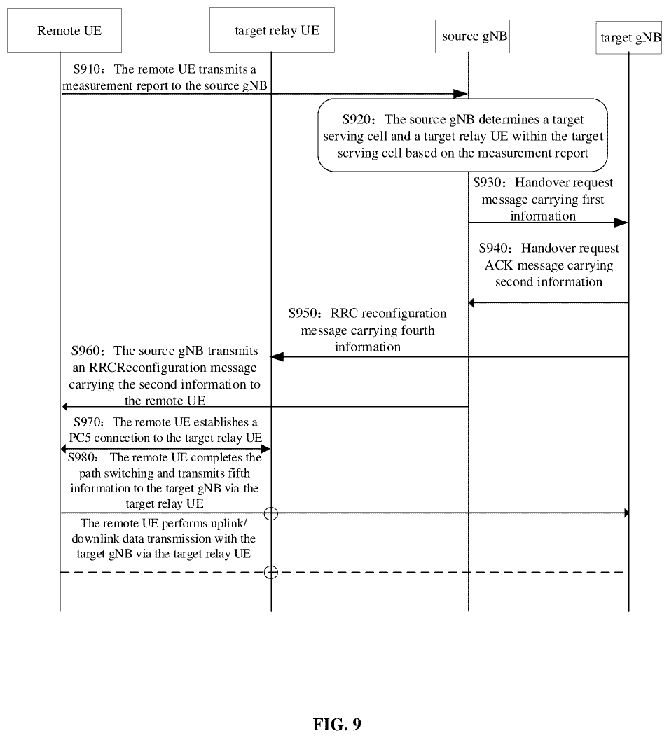

FIG. 8 is a schematic flowchart of a switching method according to some embodiments of a third aspect of the present disclosure. The method is applicable to the system shown in FIG. 1, but is not limited thereto. The method includes at least some of the following processes.

In S810, a remote terminal device receives second information from a source network device, wherein the second information is configured to instruct the remote terminal device to switch to connect to a target network device via a target relay terminal device.

In the embodiments, the network device is a RAN device, the source network device refers to a source RAN device, and the target network device refers to a target RAN device. More specifically, the RAN device refers to a base station on the network side, such as a gNB, eNB, or the like.; the source network device is specifically a source base station; and the target network device is specifically a target base station. It should be understood that the source network device is different from the target network device.

The remote terminal device is referred to as a U2N remote terminal device. A service cell in which the remote terminal device is currently located is referred to as a source cell, and a network device corresponding to the source cell is the aforementioned source network device.

The target relay terminal device is referred to as a target U2N relay terminal device. The target relay terminal device is a relay terminal device within the target serving cell to which the remote terminal device switches. A network device corresponding to the target serving cell is the aforementioned target network device.

Prior to S810, the method further includes: generating, by the remote terminal device, a measurement report. The measurement report is acquired by the remote terminal device performing measurements on messages transmitted by candidate relay terminal devices and over legacy Uu interfaces.

The measurement report includes at least one of an identifier of the candidate relay terminal device, a signal strength of the candidate relay terminal device, an identifier of a candidate cell to which the candidate relay terminal device belongs, or a signal strength of the candidate cell to which the candidate relay terminal device belongs.

The number of candidate relay terminal devices in the measurement report is one or more, which is not limited herein. The identifier of the candidate relay terminal device specifically refers to the identifier of each candidate relay terminal device among all candidate relay terminal devices. The identifier of any one of the candidate relay terminal devices is an ID of the candidate relay terminal device. In some embodiments, the ID of the candidate relay terminal device is represented by any one of a TMSI, an IMSI, an I-RNTI, or an I-RNTI.

The candidate relay terminal devices satisfy a relay selection criterion. The relay selection criterion at least includes a condition that an RSC satisfies a requirement. That is, an RSC supported by the candidate relay terminal device is an RSC that is required by the remote terminal device. The remote terminal device determines the candidate relay terminal devices via a Model A discovery process or a Model B discovery process. Specifically, the description is given hereinafter.

In the Model A discovery process, the remote terminal device selects a relay terminal device whose RSC meets the requirement as the candidate relay terminal device based on RSCs contained in announcement messages received from the respective relay terminal devices. For example, the remote terminal device receives announcement messages from five relay terminal devices, and the remote terminal device acquires an RSC supported by each of the five relay terminal devices from the announcement messages; in a case where the RSCs of three relay terminal devices among the five relay terminal devices are the RSCs required by the remote terminal device, the three relay terminal devices are candidate relay terminal devices for the remote terminal device.

In the model B discovery process, the remote terminal device transmits a solicitation message containing an RSC needed by the remote terminal device itself, and in a case where there is a relay terminal device around the remote terminal device that supports the RSC, the relay terminal device transmits a response message to the remote terminal device, and the remote terminal device determines the relay terminal device that transmits the response message as the candidate relay terminal device. For example, there are six relay terminal devices around the remote terminal device, and the remote terminal device transmits a solicitation message containing an RSC needed by the remote terminal device itself; in a case where there are three relay terminal devices around the remote terminal device that are capable of supporting the RSC, the three relay terminal devices transmit response messages to the remote terminal device; and the remote terminal device determines these three relay terminal devices as the candidate relay terminal devices.

The signal strength of the candidate relay terminal device in the measurement report refers specifically to a signal strength of each candidate relay terminal device among all candidate relay terminal devices. The signal strength of any one of the candidate relay terminal devices specifically refers to a received signal strength of the candidate relay terminal device measured by the remote terminal device.

As described above, the relay discovery includes the Model A discovery process or the model B discovery process. The processing of the received signal strength of the candidate relay terminal device measured by the remote terminal device is described in connection to the aforementioned Model A discovery process or model B discovery process. In the Model A discovery process, the received signal strength of the candidate relay terminal device measured by the remote terminal device includes the received signal strength of the announcement message transmitted by each candidate relay terminal device measured by the remote terminal device. In the Model B discovery process, the remote terminal device actively transmits its own desired RSC and then receives the response message from the candidate relay terminal device, and the signal strength of the candidate relay terminal device refers specifically to the received signal strength of the response message measured by the remote terminal device.

The identifier of the candidate cell to which the candidate relay terminal device belongs in the measurement report specifically refers to the identifier of the candidate cell to which each of the candidate relay terminal devices belongs, for example, it is expressed as the ID of the candidate cell to which each candidate relay terminal device belongs.

The identifier of the candidate cell to which the candidate relay terminal device belongs is carried by related information transmitted by the candidate relay terminal device. For example, the identifier of the candidate cell to which the candidate relay terminal device belongs is carried in the announcement message in the Model A discovery process; or the identifier of the candidate cell to which the candidate relay terminal device belongs is carried in the response message in the Model B discovery process.

The signal strength of the candidate cell to which the candidate relay terminal device belongs in the measurement report is acquired by the remote terminal device performing a legacy Uu interface measurement. The signal strength of the candidate cell includes an RSRP measurement result and/or an RSRQ measurement result. The legacy Uu Interface measurement is performed based on a measurement configuration. The measurement configuration is mainly transmitted by the source network device over a measurement configuration (measConfig) clement carried by an RRCConnectionReconfigurtion message. The measurement configuration contains at least one of an object to be measured by the remote terminal device, a list of cells, a reporting method, a measurement identifier, or an event parameter.

It should be noted that all of the above are included in the measurement report. That is, one measurement report includes the identifier of the candidate relay terminal device, the signal strength of the candidate relay terminal device, the identifier of the candidate cell to which the candidate relay terminal device belongs, and the signal strength of the candidate cell to which the candidate relay terminal device belongs. Alternatively, the measurement report includes some of the above. For example, one measurement report includes the identifier of the candidate relay terminal device and the identifier of a candidate cell to which the candidate relay terminal device belongs; or one measurement report includes the identifier of the candidate relay terminal device and the signal strength of the candidate relay terminal device, which are not exhausted herein.

In a case where the remote terminal device generates the measurement report, the method further includes: transmitting, by the remote terminal device, the measurement report to the source network device. Specifically, the remote terminal device transmits the measurement report to the source network device in different ways in different scenarios.

In one scenario, the remote terminal device and the source network device are directly connected. That is, the data transmission is directly performed between the remote terminal device and the source network device over a Uu interface. Accordingly, transmitting the measurement report from the remote terminal device to the source network device includes: directly transmitting the measurement report to the source network device over the Uu interface.

In this scenario, upon completion of the foregoing processing, S810 is performed. That is, the remote terminal device receives the second information from the source network device.

The remote terminal device receiving the second information from the source network device specifically includes: receiving the second information transmitted directly by the source network device over the Uu interface.

In another scenario, the connection (or data transmission) is achieved between the remote terminal device and the source network device by a source relay terminal device. Accordingly, the remote terminal device transmitting the measurement report to the source network device includes: transmitting the measurement report to the source network device via the source relay terminal device. The connection between the remote terminal device and the source relay terminal device is specifically a PC5 connection, and the data transmission is achieved between the source relay terminal device and the source network device over the Uu interface.

In this scenario, upon completion of the foregoing processing, S810 is performed. That is, the remote terminal device receives the second information from the source network device. The remote terminal device receiving the second information from the source network device includes: receiving the second information from the source network device via the source relay terminal device.

In either of the above scenarios, the second information includes the identifier of the target relay terminal device; additionally, the second information includes the identifier of the target serving cell. The second information is specifically a handover command carried by an RRC reconfiguration message.

Upon completion of S810, the method further includes:
in a case where the remote terminal device establishes a connection to the target relay terminal device, the remote terminal device transmits fifth information to the target network device via the target relay terminal device. The fifth information indicates that the remote terminal device completes the path switching.

The fifth information is carried by an RRC reconfiguration completion message.

Specifically, the remote terminal device determines the target relay terminal device based on the identifier of the target relay terminal device indicated in the second information and establishes a PC5 connection to the target relay terminal device. In a case where the PC5 connection to the target relay terminal device is successfully established, the remote terminal device transmits the fifth information to the target network device via the target relay terminal device. The fifth message indicates that the remote terminal device completes the path switching.

Upon completion of the foregoing processing, the remote terminal device is capable of performing uplink and/or downlink data transmission with the target network device via the target relay terminal device.

In the aforementioned scheme, the remote terminal device is capable of receiving the second information from the source network device, such that the remote terminal device is capable of switching to establish a connection to the target network device via the target relay terminal device. In this way, the remote terminal device is capable of achieving the switching of network devices, and then the problem of packet loss caused by the remote terminal device failing to establish a connection to the target network device via the target relay terminal device as soon as possible during the process of switching of network devices is avoided.

Using a scenario where the remote terminal device is a remote UE, the target relay terminal device is a target relay UE, the candidate relay terminal device is a candidate relay UE, the source network device is a source gNB, and the target network device is a target gNB as an example, the switching method according to the embodiments in the first aspect, the second aspect, and the third aspect is illustratively described hereinafter in conjunction with FIG. 9.

In S910, the remote UE transmits a measurement report to the source gNB.

The measurement report is configured to report candidate relay UEs and legacy Uu measurements.

The candidate relay UEs reported by the remote UE must all satisfy relay selection criteria, e.g., a relay service code (RSC) meets a requirement. That is, RSCs supported by the candidate relay UEs are RSCs required by the remote terminal device.

The measurement report includes at least one of an ID of the candidate relay UE, a signal strength of the candidate relay UE, an identifier of a candidate cell to which the candidate relay UE belongs, or a signal strength of the candidate cell to which the candidate relay UE belongs.

The uplink and/or downlink data transmission is performed directly between the remote UE and the source gNB (over a Uu interface).

In S920, the source gNB determines a target serving cell and a target relay UE within the target serving cell based on the measurement report.

Specifically, the source gNB determines the target serving cell from the candidate cells based on the measurement report. The source gNB determines the candidate relay UEs within the target serving cell based on the measurement report and determines the target relay UE that satisfies a predetermined condition from the candidate relay UEs within the target serving cell. The predetermined condition includes at least one of a minimum load or a maximum signal strength.

That is, in a case where the source gNB decides to initiate switching the path of the remote UE to connect to the target gNB via the target relay UE, the source gNB first determines a target serving cell, and then determines the target relay UE satisfying the predetermined conditions from the candidate relay UEs within the target serving cell.

Further, the source gNB generates first information, and the first information is configured to determine the target relay terminal device. The first information includes at least one of an ID of the target serving cell or an ID of the target relay UE within the target serving cell.

In S930, the source gNB transmits a handover request message carrying the first information to the target gNB.

The first information is configured to determine the target relay terminal device, and the first information includes at least one of the ID of the target serving cell or the ID of the target relay UE within the target serving cell.

In the embodiments, the handover request message carrying the first information is transmitted directly to the target gNB.

In S940, the target gNB transmits a handover request acknowledge (ACK) message carrying second information to the source gNB.

The second information includes an identifier of the target relay terminal device. Additionally, the second information includes an identifier of the target serving cell.

In S950, the target gNB transmits an RRCReconfiguration message carrying fourth information to the target relay UE, wherein the fourth information is configured to instruct the target relay UE to establish a connection to the remote UE.

In S960, the source gNB transmits an RRCReconfiguration message carrying the second information to the remote UE.

It should be noted that the above S950 and S960 are performed in no particular order. That is, S950 is performed prior to S960, S960 is performed prior to S950, or S950 and S960 are performed simultaneously.

In S970, the remote UE establishes a PC5 connection to the target relay UE.

In S980, the remote UE completes the path switching and transmits fifth information to the target gNB via the target relay UE, wherein the fifth information is carried by an RRCReconfigurationComplete message and indicates that the remote terminal device completes the path switching.

With the above processing, the data path between the remote UE and the target gNB is switched to a non-direct connection mode, and the remote UE performs uplink and/or downlink data transmission with the target gNB via the target relay UE.

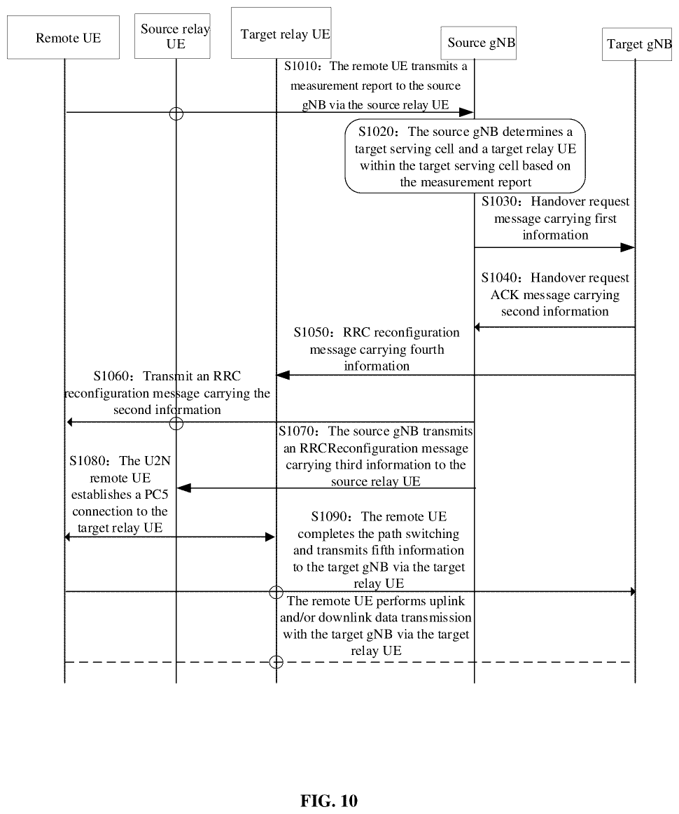

Using a scenario where the remote terminal device is a remote UE, the target relay terminal device is a target relay UE, the candidate relay terminal device is a candidate relay UE, the source relay terminal device is a source relay UE, the source network device is a source gNB, and the target network device is a target gNB as an example, in conjunction with FIG. 10, the switching method according to the embodiments in the first aspect, the second aspect, and the third aspect is illustratively described hereinafter.

In S1010, the remote UE transmits a measurement report to the source gNB via the source relay UE.

The description related to the measurement report is the same as in the previous embodiments, which is not repeated herein.

Uplink and/or downlink data transmission is achieved between the remote UE and the source gNB by the source relay UE.

In S1020, the source gNB determines a target serving cell and a target relay UE within the target serving cell based on the measurement report.

The specific processing of S1020 is the same as that of S920, which is not repeated herein.

In S1030, the source gNB transmits a handover request message carrying first information to the target gNB.

The first information is configured to determine a target relay terminal device. The first information includes at least one of: an ID of a target serving cell or an ID of the target relay UE within the target serving cell.

In the embodiments, the handover request message carrying the first information is transmitted directly to the target gNB.

In S1040, the target gNB transmits a handover request ACK message carrying second information to the source gNB.

The second information includes an identifier of the target relay terminal device. Additionally, the second information includes an identifier of the target serving cell.

In S1050, the target gNB transmits an RRCReconfiguration message carrying fourth information to the target relay UE, wherein the fourth information is configured to instruct the target relay UE to establish a connection to the remote UE.

In S1060, the source gNB transmits an RRCReconfiguration message carrying the second information to the remote UE via the source relay UE.

It should be noted that the above S1050 and S1060 are performed in no particular order. That is, S1050 is performed prior to S1060, S1060 is performed prior to S1050, or S1050 and S1060 are performed at the same time.

In S1070, the source gNB transmits an RRCReconfiguration message carrying third information to the source relay UE, wherein the third information is configured to instruct the source relay terminal device to release a connection to the remote terminal device.

In S1080, the U2N remote UE establishes a PC5 connection to the target relay UE.

In S1090, the remote UE transmits fifth information to the target gNB via the target relay UE, wherein the fifth information is carried by an RRCReconfigurationComplete message and indicates that the remote terminal device completes the path switching.

With the above processing, the data path between the remote UE and the target gNB is switched to a non-direct connection mode. The remote UE performs uplink and/or downlink data transmission with the target gNB via the target relay UE.

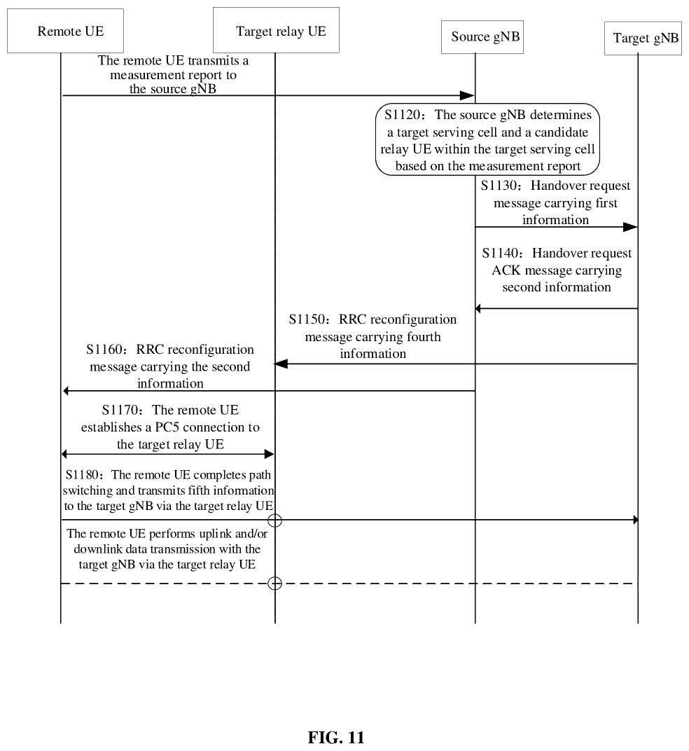

Using a scenario where the remote terminal device is a remote UE, the target relay terminal device is a target relay UE, the candidate relay terminal device is a candidate relay UE, the source relay terminal device is a source relay UE, the source network device is a source gNB, and the target network device is a target gNB as an example, in conjunction with FIG. 11, the switching method according to the embodiments in the first aspect, the second aspect, and the third aspect is illustratively described hereinafter.

In S1110, the remote UE transmits a measurement report to the source gNB.

The description related to the measurement report is the same as that of the preceding embodiments, which is not repeated here.

Uplink and/or downlink data transmission is directly achieved between the remote UE and the source gNB is over a Uu interface.

In S1120, the source gNB determines a target serving cell and a candidate relay UE within the target serving cell based on the measurement report.

Specifically, the source gNB determines the target serving cell from the candidate cells based on the measurement report, and the source gNB determines the candidate relay UEs within the target serving cell based on the measurement report.

That is, in a case where the source gNB decides to initiate switching the path of the remote UE to connect to the target gNB via the target relay UE, the source gNB first determines the target serving cell and then determines the candidate relay UE within the target serving cell.

In S1130, the source gNB transmits a handover request message carrying first information to the target gNB.

The first information is configured to determine a target relay terminal device, and the first information includes at least one of an ID of a target serving cell, an ID of a candidate relay UE within the target serving cell, or a signal strength of the candidate relay UE within the target serving cell.

In the embodiments, the handover request message carrying the first information is transmitted directly to the target gNB.

In S1140, the target gNB transmits a handover request ACK message carrying second information to the source gNB.

The target network device determines the target relay terminal device that satisfies a predetermined condition from the candidate relay terminal devices within the target serving cell in the first information, wherein the predetermined condition includes at least one of a minimum load or a maximum signal strength.

Further, the target gNB generates the second information based on the target relay terminal device and the target serving cell in which the target relay terminal device is located. The second information includes an identifier of the target relay terminal device. Additionally, the second information includes an identifier of the target serving cell.

In S1150, the target gNB transmits an RRCReconfiguration message carrying fourth information to the target relay UE, wherein the fourth information is configured to instruct the target relay UE to establish a connection to the remote UE.

In S1160, the source gNB transmits an RRCReconfiguration message carrying the second information to the remote UE.

It should be noted that the above S1150 and S1160 are performed in no particular order. That is, S1150 is performed prior to S1160, S1160 is performed prior to S1150, or S1150 and S1160 are performed simultaneously.

In S1170, the remote UE establishes a PC5 connection to the target relay UE.

In S1180, the remote UE transmits fifth information to the target gNB via the target relay UE, wherein the fifth information is carried by an RRCReconfigurationComplete message and indicates that the remote terminal device completes the path switching.

With the above processing, the data path between the remote UE and the target gNB is switched to a non-direct connection mode. The remote UE performs uplink and/or downlink data transmission with the target gNB via the target relay UE.

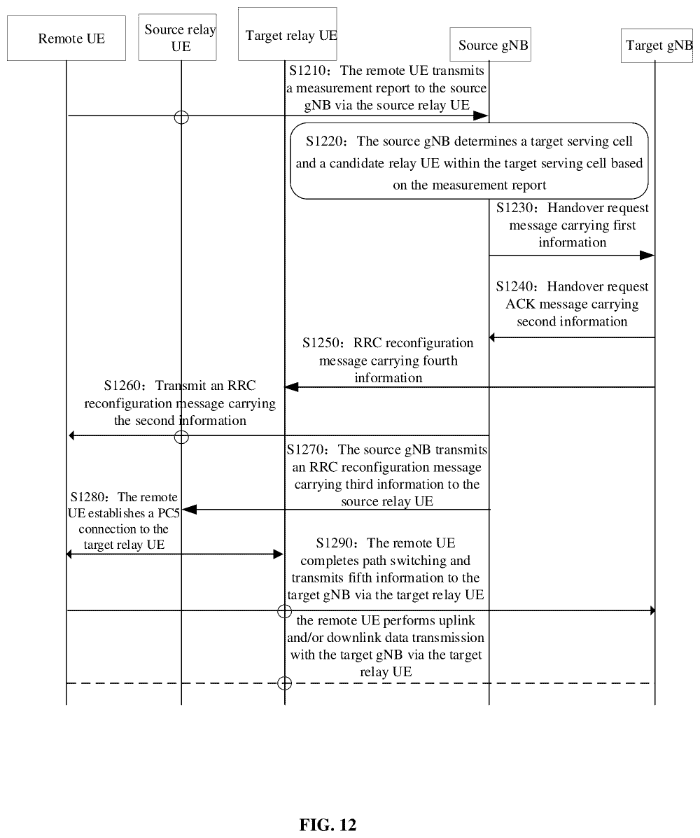

Using a scenario where the remote terminal device is a U2N remote UE, the target relay terminal device is a target candidate relay UE, the candidate relay terminal device is a candidate relay UE, the source relay terminal device is a source relay UE, the source network device being a source gNB, and the target network device is a target gNB as an example, the switching method according to the embodiments in the first aspect, the second aspect, and the third aspect is illustratively described hereinafter in conjunction with FIG. 12.

In S1210, the remote UE transmits a measurement report to the source gNB via the source relay UE.

The description related to the measurement report is the same as that of the previous embodiments, which is not repeated herein.

Uplink and/or downlink data transmission is achieved between the remote UE and the source gNB by the source relay UE.

In S1220, the source gNB determines a target serving cell and a candidate relay UE within the target serving cell based on the measurement report.

The specific processing of S1220 is the same as that of S1120, which is not repeated herein.

In S1230, the source gNB transmits a handover request message carrying first information to the target gNB.

The first information is configured to determine a target relay terminal device, and the first information includes at least one of an ID of a target serving cell, an ID of a candidate relay UE within the target serving cell, or a signal strength of the candidate relay UE within the target serving cell.

In the embodiments, the handover request message carrying the first information is transmitted directly to the target gNB.

In S1240, the target gNB transmits a handover request ACK message carrying second information to the source gNB.

The target network device determines, from the candidate relay terminal devices within the target serving cell in the first information, the target relay terminal device that satisfies a predetermined condition; wherein the predetermined condition includes at least one of a minimum load or a maximum signal strength.

Further, the target gNB generates the second information based on the target relay terminal device and the target serving cell in which the target relay terminal device is located. The second information includes an identifier of the target relay terminal device. Additionally, the second information includes an identifier of the target serving cell.

S1250, the target gNB transmits an RRCReconfiguration message carrying fourth information to the target relay UE, wherein the fourth information is configured to instruct the target relay UE to establish a connection to the remote UE.

In S1260, the source gNB transmits an RRCReconfiguration message carrying the second information to the remote UE via the source relay UE.

It should be noted that the above S1250 and S1260 are performed in no particular order. That is, S1250 is performed prior to S1260, S1260 is performed prior to S1250, or S1250 and S1260 are performed simultaneously.

In S1270, the source gNB transmits an RRCReconfiguration message carrying third information to the source relay UE, wherein the third information is configured to instruct the source relay terminal device to release the connection to the remote terminal device.

In S1280, the remote UE establishes a PC5 connection to the target relay UE.

In S1290, the remote UE completes path switching and transmits fifth information to the target gNB via the target relay UE, wherein the fifth information is carried by an RRCReconfigurationComplete message and indicates that the remote terminal device completes the path switching.

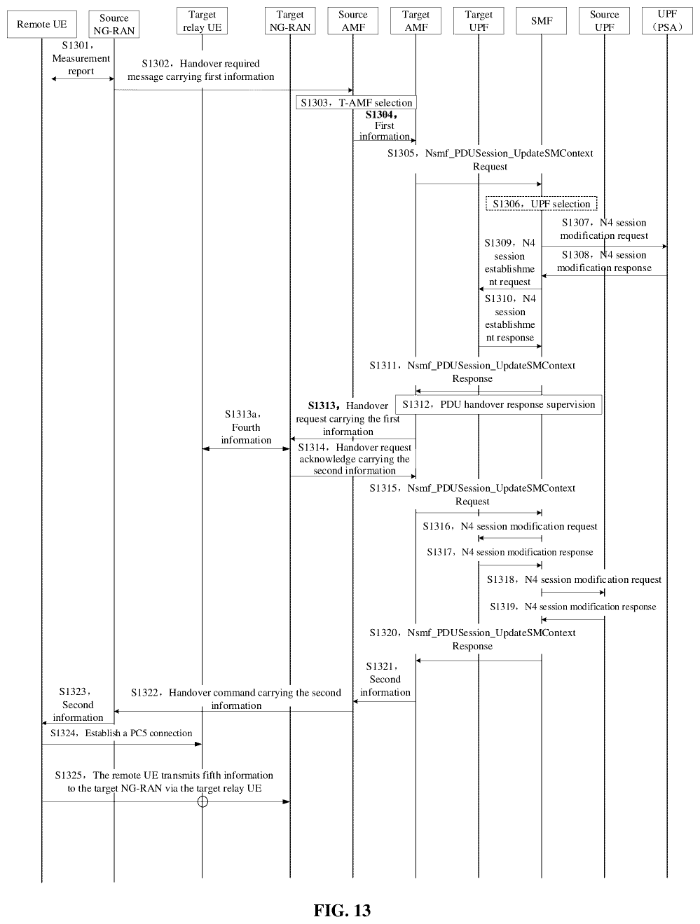

Using a scenario where the remote terminal device is a remote UE, the target relay terminal device is a target relay UE, the candidate relay terminal device is a candidate relay UE, the source relay terminal device is a source relay UE, the source network device is a source NG-RAN, and the target network device is a target NG-RAN as an example, the switching method according to the embodiments in the first aspect, the second aspect, and the third aspect is illustratively described hereinafter in conjunction with FIG. 13.

In S1301, the remote UE transmits a measurement report to the source NG-RAN.

Herein, the remote UE transmits uplink and/or downlink user-plane data with a core network device (which is specifically a UPF) via the source NG-RAN.

The relevant description of the measurement report is the same as that of the preceding embodiments, which is not repeated herein.

In S1302, the source NG-RAN transmits a handover required message carrying first information to a source AMF.

Specifically, the source NG-RAN determines a target NG-RAN and candidate relay UEs under the target NG-RAN based on the measurement report. The source NG-RAN transmits the handover required message carrying the first information to the source AMF in response to a decision to trigger a relocation over N2.

In this process, the first information includes an ID of the target NG-RAN (e.g., the target gNB) and an ID of the candidate relay UE under the target NG-RAN (e.g., the target gNB).

Alternatively, this first information includes a target TAI, which is not exhaustive herein.

In S1303, the source AMF selects a target AMF (T-AMF Selection).

In S1304, the source AMF transmits the first information to the target AMF, which is carried by a Namf_Communication_CreateUEContext request.

In S1305, the target AMF transmits a Nsmf_PDUSession_UpdateSMContext request to the SMF.

In S1306, SMF selects a UPF (UPF Selection).

In S1307, the SMF transmits an N4 session modification request to a PSA UPF.

In S1308, the PSA UPF transmits an N4 session modification response to the SMF.

In S1309, the SMF transmits an N4 session establishment request to a target UPF.

In S1310, the target UPF transmits an N4 session establishment response to the SMF.

In S1311, the SMF transmits a Nsmf_PDUSession_UpdateSMContext response to the target AMF.

In S1312, a PDU handover response supervision is performed between the target AMF and the SMF.

In S1313, the target AMF transmits a handover request carrying the first information to the target NG-RAN.

In this process, the target NG-RAN determines the target relay UE based on the first information, and a target serving cell is selected.

Further, upon completion of this step, the target NG-RAN generates second information based on the target relay UE.

In S1313a, the target NG-RAN transmits fourth information to the target relay UE, wherein the fourth information is carried by an RRC reconfiguration message, and the fourth information is configured to instruct the target relay UE to establish a connection to the remote UE.

In S1314, the target NG-RAN transmits a handover request acknowledge carrying the second information to the target AMF.

In S1315, the target AMF transmits the Nsmf_PDUSession_UpdateSMContext request to the SMF.

In S1316, the SMF transmits the N4 session modification request to the target UPF.

In S1317, the target UPF transmits the N4 session modification response to the SMF.

In S1318, the SMF transmits the N4 session modification request to a source UPF.

In S1319, the source UPF transmits the N4 session modification response to the SMF.

In S1320, the SMF transmits the Nsmf_PDUSession_UpdateSMContext response to the target AMF.

In S1321, the target AMF transmits the second information to the source AMF, wherein the second information is carried by the Namf_Communication_CreateUEContext response.

In S1322, the source AMF transmits a handover command carrying the second information to the source NG-RAN.

In S1323, the source NG-RAN transmits the second information to the remote UE, wherein the second information is carried by the RRCReconfiguration message.

In S1324, the remote UE establishes a PC5 connection to the target relay UE.

In S1325, the remote UE transmits fifth information to the target NG-RAN via the target relay UE, wherein the fifth information is carried by an RRCReconfigurationComplete message and indicates that the remote terminal device completes the path switching.

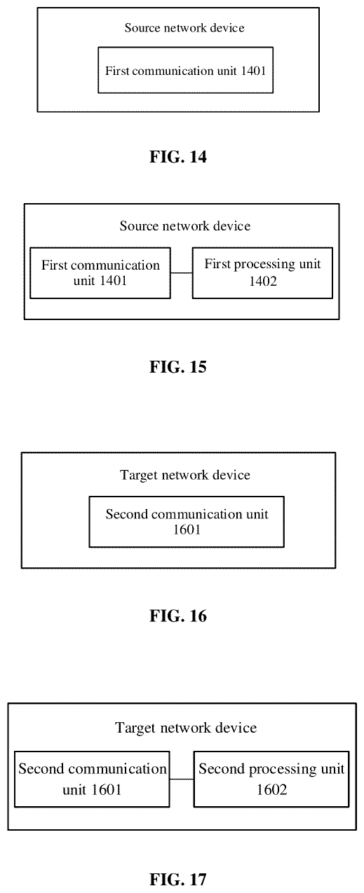

FIG. 14 is a schematic block diagram of a source network device according to some embodiments of the present disclosure.

The source network device includes: a first communication unit 1401, configured to transmit first information to a target network device, wherein the first information is configured to determine a target relay terminal device; and receive second information from the target network device and to transmit the second information to a remote terminal device, wherein the second information is configured to instruct the remote terminal device to switch to connect to the target network device via the target relay terminal device.

The first information includes at least one of: an identifier of a target serving cell; or an identifier of the target relay terminal device within a target serving cell.

As shown in FIG. 15, the source network device further includes: a first processing unit 1402, configured to: determine, based on a measurement report, the target serving cell from candidate cells; determine, based on the measurement report, candidate relay terminal devices within the target serving cell; and determine, from the candidate relay terminal devices within the target serving cell, the target relay terminal device that satisfies a predetermined condition; wherein the predetermined condition includes at least one of a minimum load or a maximum signal strength.

The first information includes at least one of: the identifier of the target serving cell; an identifier of a candidate relay terminal device within a target serving cell; or a signal strength of a candidate relay terminal device within a target serving cell.

The first processing unit 1402 is configured to determine the target serving cell from the candidate cells based on the measurement report and determine the candidate relay terminal devices within the target serving cell based on the measurement report.

The first information includes at least one of: an identifier of a target network device; an identifier of a candidate relay terminal device within the target network device; or a signal strength of a candidate relay terminal device within the target network device.

The first processing unit 1402 is configured to determine, based on the measurement report, the target network device corresponding to the target serving cell from the candidate cells and determine, based on the measurement report, the candidate relay terminal devices within the target network device.

The first communication unit 1401 is configured to transmit the first information to the target network device via a core network device.

The first communication unit is configured to receive the second information from the target network device via the core network device.

The first communication unit is configured to transmit the second information to the remote terminal device via a source relay terminal device.

The first communication unit is configured to transmit third information to the source relay terminal device, wherein the third information is configured to instruct the source relay terminal device to release a connection to the remote terminal device.

The first communication unit is configured to receive the measurement report from the remote terminal device.

The first communication unit is configured to receive the measurement report from the remote terminal device via the source relay terminal device.

The measurement report includes at least one of: an identifier of the candidate relay terminal device; a signal strength of the candidate relay terminal device; an identifier of a candidate cell to which the candidate relay terminal device belongs; or a signal strength of the candidate cell to which the candidate relay terminal device belongs.

The second information includes an identifier of the target relay terminal device.

The source network device of the embodiments of the present disclosure is capable of implementing the corresponding functions of the source network device in the aforementioned embodiments in the first aspect, the second aspect, and the third aspect. The corresponding processes, functions, achievement methods, and beneficial effects of the various modules (submodules, units, or components) in this source network device may be found in the corresponding descriptions in the above-described method embodiments and are not repeated hercin. It should be noted that the functions described with respect to the individual modules (sub-modules, units, or components) in the network device of the application embodiments may be implemented by different modules (sub-modules, units, or components) or may be implemented by the same module (sub-module, unit, or component).

FIG. 16 is a schematic block diagram of a target network device according to some embodiments of the present disclosure. The target network device includes:
a second communication unit 1601, configured to receive first information from a source network device, wherein the first information is configured to determine a target relay terminal device; and transmit second information to the source network device, wherein the second information is configured to instruct a remote terminal device to switch to connect to the target network device via the target relay terminal device.

The first information includes at least one of: an identifier of a target serving cell; or an identifier of the target relay terminal device within a target serving cell.

As shown in FIG. 17, the target network device further includes: a second processing unit 1602, configured to determine the target relay terminal device based on the first information.

The first information includes at least one of: the identifier of the target serving cell; an identifier of a candidate relay terminal device within a target serving cell; or a signal strength of a candidate relay terminal device within a target serving cell.

The second processing unit is configured to determine candidate relay terminal devices within the target serving cell based on the first information and determine the target relay terminal device that satisfies a predetermined condition from the candidate relay terminal devices within the target serving cell, wherein the predetermined condition includes at least one of a minimum load or a maximum signal strength.

The first information includes at least one of: an identifier of the target network device; an identifier of a candidate relay terminal device within the target network device; or a signal strength of a candidate relay terminal device within the target network device.

The second processing unit is configured to determine the candidate relay terminal devices within the target network device based on the first information and determine the target relay terminal device that satisfies a predetermined condition from the candidate relay terminal devices within the target network device, wherein the predetermined condition includes at least one of: a minimum load or a maximum signal strength.

The second communication unit is configured to receive the first information from the source network device via a core network device.

The second communication unit is configured to transmit the second information to the source network device via the core network device.

The second information includes an identifier of the target relay terminal device.

The second communication unit is configured to transmit fourth information to the target relay terminal device; wherein the fourth information is configured to instruct the target relay terminal device to establish a connection to the remote terminal device.

The second communication unit is configured to receive fifth information from the remote terminal device via the target relay terminal device; wherein the fifth information indicates that the remote terminal device completes the path switching.

The target network device according to the embodiments of the present disclosure is capable of achieving the corresponding functions of the target network device in the aforementioned embodiments in the first aspect, the second aspect, and the third aspect. The corresponding processes, functions, achievement methods, and beneficial effects of the various modules (submodules, units, or components) in this target network device may be found in the corresponding descriptions in the above-described method embodiments and are not repeated herein. It should be noted that the functions described with respect to the individual modules (sub-modules, units, or components) in the target network device of the application embodiments may be implemented by different modules (sub-modules, units, or components) or may be implemented by the same module (sub-module, unit, or component).

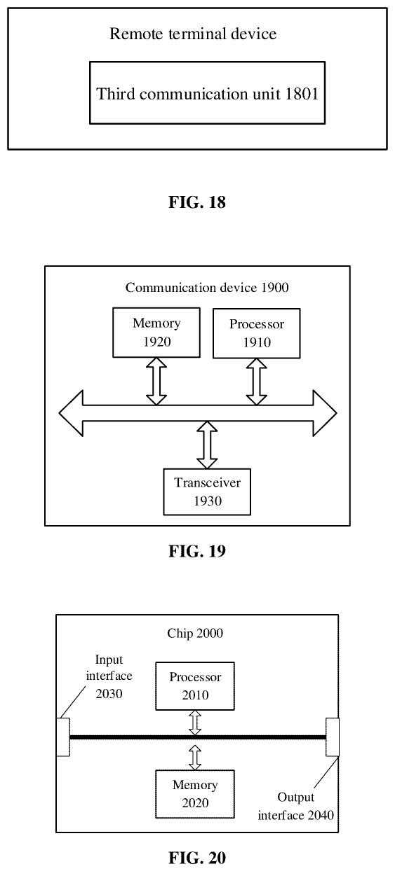

FIG. 18 is a schematic block diagram of a remote terminal device according to some embodiments of the present disclosure.

The target network device includes: a third communication unit 1801, configured to receive second information from a source network device; wherein the second information is configured to instruct the remote terminal device to switch to connect to the target network device via a target relay terminal device.

The third communication unit is configured to transmit fifth information to the target network device via the target relay terminal device in a case where the remote terminal device establishes a connection to the target relay terminal device; wherein the fifth information indicates that the remote terminal device completes the path switching.

The third communication unit is configured to transmit a measurement report to the source network device.

The third communication unit is configured to transmit the measurement report to the source network device via a source relay terminal device.

The measurement report includes at least one of: an identifier of a candidate relay terminal device, a signal strength of a candidate relay terminal device, an identifier of a candidate cell to which a candidate relay terminal device belongs, or a signal strength of a candidate cell to which a candidate relay terminal device belongs.

The third communication unit is configured to receive the second information from the source network device via the source relay terminal device.

The second information includes an identifier of the target relay terminal device.

It should be noted that the remote terminal device further includes a third processing unit which performs processing such as generating the measurement report and parsing the second information to determine communication resources, which are not exhaustively described herein.

The remote terminal device of the embodiments of the present disclosure is capable of implementing the corresponding functions of the remote terminal device in the aforementioned embodiments in the first aspect, the second aspect, and the third aspect. The corresponding processes, functions, achievement methods, and beneficial effects of the various modules (sub-modules, units, or components) in this remote terminal device may be found in the corresponding descriptions in the above-described method embodiments, and are not repeated herein. It should be noted that the functions described with respect to each module (sub-module, unit, or component) in the remote terminal device of the application embodiments may be implemented by different modules (sub-modules, units, or components) or may be implemented by the same module (sub-module, unit, or component).

FIG. 19 is a schematic structural diagram of a communication device 1900 according to some embodiments of the present disclosure. The communication device 1900 includes a processor 1910. The processor 1910, when loading and running at least one computer program from a memory, causes the communication device 1900 to perform the methods according to the embodiments of the present disclosure.

In some embodiments, the communication device 1900 further includes a memory 1920. The processor 1910, when calling and running at least one computer program stored in the memory 1920, causes the communication device 1900 to perform the methods according to the embodiments of the present disclosure.

The memory 1920 is a separate device from the processor 1910 or is integrated into the processor 1910.

In some embodiments, the communication device 1900 further includes a transceiver 1930. The processor 1910 controls the transceiver 1930 to communicate with other devices, specifically, to transmit information or data to other devices or to receive information or data from other devices.

The transceiver 1930 includes a transmitter and a receiver. The transceiver 1930 further includes one or more antennas.

In some embodiments, the communication device 1900 is the network device according to the embodiments of the present disclosure. The communication device 1900 is capable of implementing the corresponding processes implemented by the network device in the various methods of the embodiments of the present disclosure, which are not repeated herein for brevity.

In some embodiments, the communication device 1900 is the terminal device according to the embodiments of the present disclosure. The communication device 1900 is capable of implementing the corresponding processes implemented by the terminal device in the various methods according to the embodiments of the present disclosure, which are not repeated herein for brevity.

FIG. 20 is a schematic structural diagram of a chip 2000 according to some embodiments of the present disclosure. The chip 2000 includes a processor 2010. The processor 2010, when loading and running at least one computer program from a memory, is caused to perform the methods according to the embodiments of the present disclosure.

In some embodiments, the chip 2000 further includes a memory 2020. The processor 2010, when loading and running at least one computer program from the memory 2020, is caused to perform the methods according to the embodiments of the present disclosure.

The memory 2020 is a separate device from the processor 2010 or is integrated into the processor 2010.

In some embodiments, the chip 2000 further includes an input interface 2030. The processor 2010 controls the input interface 2030 to communicate with other devices or chips, specifically, to acquire information or data transmitted by other devices or chips.

In some embodiments, the chip 2000 further includes an output interface 2040. The processor 2010 controls the output interface 2040 to communicate with other devices or chips, specifically, to output information or data to other devices or chips.

In some embodiments, the chip is applied to a network device according to the embodiments of the present disclosure. The chip is capable of implementing the corresponding processes implemented by the network device in the various methods according to the embodiments of the present disclosure, which are not repeated herein for brevity.

In some embodiments, the chip is applied to a terminal device in the embodiments of the present disclosure. The chip is capable of implementing the corresponding processes implemented by the terminal device in the various methods of the embodiments of the present disclosure, which are not repeated herein for brevity.

The chips applied to the network device and the terminal device are the same chip or different chips.

It should be understood that the chip according to the embodiments of the present disclosure is also referred to as a system-on-chip, a system chip, a chip system, or the like.

The processor referred to above is a general-purpose processor, a digital signal processor (DSP), a field programmable gate array (FPGA), an application-specific integrated circuit (ASIC), another programmable logic device, a transistor logic device, a discrete hardware component, or the like. The above-mentioned general-purpose processor is a microprocessor or any conventional processor.

The memory referred to above is transitory or non-transitory, or includes both the volatile and non-transitory memories. The non-transitory memory is a read-only memory (ROM), a programmable ROM (PROM), an erasable programmable read-only memory (EPROM), an electrically erasable programmable read-only memory (EEPROM), or a flash memory. The transitory memory is a random access memory (RAM).

It should be understood that the above memories are exemplary but not limiting descriptions. For example, the memory according to the embodiments of the present disclosure is a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct Rambus RAM (DR RAM), or the like. That is, the memory according to the embodiments of the present disclosure is intended to include, but is not limited to, these and any other suitable types of memory.

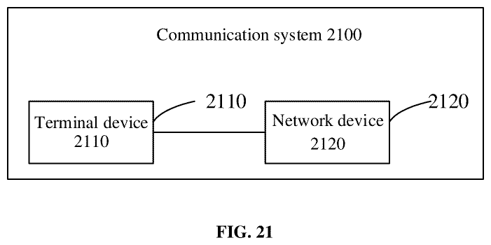

FIG. 21 is a schematic block diagram of a communication system 2100 according to some embodiments of the present disclosure. The communication system 2100 includes a terminal device 2110 and a network device 2120.

The terminal device 2110 is configured to achieve the corresponding functions implemented by the terminal device in the method described above, and the network device 2120 is configured to achieve the corresponding functions implemented by the network device in the method described above, which are not repeated herein for brevity.

In the above-described embodiments, the technical solutions may be accomplished in whole or in part by software, hardware, firmware, or any combination thereof. When implemented using software, the technical solutions may be implemented, in whole or in part, in the form of a computer program product. The computer program product includes one or more computer instructions. When loaded and executed on a computer, the computer program instructions produce, in whole or in part, a process or function in accordance with the embodiments of the present disclosure. The computer may be a general-purpose computer, a specialized computer, a computer network, or other programmable device. The computer instructions may be stored in a computer-readable storage medium or transmitted from one computer-readable storage medium to another computer-readable storage medium. For example, the computer instructions may be transmitted from a web site, a computer, a server, or a data center by wired (e.g., coaxial cable, fiber optics, or digital subscriber line (DSL)) or wireless (e.g., infrared, wireless, or microwave) means to another website site, computer, server, or data center. The computer-readable storage medium may be any usable medium to which a computer has access or a data storage device such as a server or a data center that contains one or more usable media integration. The usable medium may be a magnetic medium (e.g., a floppy disk, a hard disk, or a tape), an optical medium (e.g., a DVD), a semiconductor medium (e.g., a solid state disk (SSD)), or the like.

It should be understood that in various embodiments of the present disclosure, the magnitude of the serial number of each of the above-described processes does not imply an order of execution, and the order of execution of each of the processes should be determined by its function and inherent logic without constituting any limitation of the processes implemented in the embodiments of the present disclosure.

It is clear to those skilled in the art that, for the convenience and brevity of description, the specific working processes of the above-described systems, apparatuses, and units can be referred to the corresponding processes in the foregoing embodiments of the method, which are not repeated hercin.

Described above are merely exemplary embodiments of the present disclosure, but the scope of protection of the present disclosure is not limited thereto. Any modifications, equivalent substitutions, improvements, and the like made within the principles of the present disclosure shall be included in the protection scope of the present disclosure. Therefore, the protection scope of this application shall be subject to the protection scope of the claim.

1. A switching method, applicable to a source network device, the method comprising:
transmitting first information to a target network device, wherein the first information is configured to determine a target relay terminal device; and
receiving second information from the target network device and transmitting the second information to a remote terminal device, wherein the second information is configured to instruct the remote terminal device to switch to connect to the target network device via the target relay terminal device.

2. The method according to claim 1, wherein the first information comprises at least one of:
an identifier of a target serving cell;
an identifier of a candidate relay terminal device within a target serving cell; or
a signal strength of a candidate relay terminal device within a target serving cell.

3. The method according to claim 2, further comprising:
obtaining the candidate relay terminal device within the target serving cell based on a measurement report.

4. The method according to claim 1, wherein transmitting the first information to the target network device comprises:
transmitting the first information to the target network device via a core network device; and
receiving the second information from the target network device comprises:
receiving the second information from the target network device via the core network device.

5. The method according to claim 1, wherein transmitting the second information to the remote terminal device comprises:
transmitting the second information to the remote terminal device via a source relay terminal device, wherein the second information comprises an identifier of the target relay terminal device.

6. The method according to claim 5, further comprising:
transmitting third information to the source relay terminal device, wherein the third information is configured to instruct the source relay terminal device to release a connection to the remote terminal device.

7. The method according to claim 3, further comprising:
receiving the measurement report from the remote terminal device via a source relay terminal device.

8. The method according to claim 7, wherein the measurement report comprises at least one of:
an identifier of the candidate relay terminal device;
a signal strength of the candidate relay terminal device;
an identifier of a candidate cell to which the candidate relay terminal device belongs; or
a signal strength of the candidate cell to which the candidate relay terminal device belongs.

9. A network device, comprising: a processor and a memory configured to store at least one computer program, wherein the processor, when loading and running the at least one computer program stored in the memory, is caused to perform:
transmitting first information to a target network device, wherein the first information is configured to determine a target relay terminal device; and
receiving second information from the target network device and transmitting the second information to a remote terminal device, wherein the second information is configured to instruct the remote terminal device to switch to connect to the target network device via the target relay terminal device.

10. The network device according to claim 9, wherein the first information comprises at least one of:
an identifier of a target serving cell;
an identifier of a candidate relay terminal device within a target serving cell; or
a signal strength of a candidate relay terminal device within a target serving cell.

11. The network device according to claim 10, wherein the processor, when loading and running the at least one computer program stored in the memory, is caused to perform:
obtaining the candidate relay terminal device within the target serving cell based on a measurement report.

12. The network device according to claim 9, wherein the processor, when loading and running the at least one computer program stored in the memory, is caused to perform:
transmitting the first information to the target network device via a core network device; and
receiving the second information from the target network device comprises:
receiving the second information from the target network device via the core network device.

13. The network device according to claim 9, wherein the processor, when loading and running the at least one computer program stored in the memory, is caused to perform:
transmitting the second information to the remote terminal device via a source relay terminal device, wherein the second information comprises an identifier of the target relay terminal device.

14. The network device according to claim 13, wherein the processor, when loading and running the at least one computer program stored in the memory, is caused to perform:
transmitting third information to the source relay terminal device, wherein the third information is configured to instruct the source relay terminal device to release a connection to the remote terminal device.

15. The network device according to claim 11, wherein the processor, when loading and running the at least one computer program stored in the memory, is caused to perform:
receiving the measurement report from the remote terminal device via a source relay terminal device.

16. The network device according to claim 15, wherein the measurement report comprises at least one of:
an identifier of the candidate relay terminal device;
a signal strength of the candidate relay terminal device;
an identifier of a candidate cell to which the candidate relay terminal device belongs; or
a signal strength of the candidate cell to which the candidate relay terminal device belongs.

17. A terminal device, comprising: a processor and a memory configured to store at least one computer program, wherein the processor, when loading and running the at least one computer program stored in the memory, is caused to perform:
receiving second information from a source network device, wherein the second information is configured to instruct the remote terminal device to switch to connect to a target network device via a target relay terminal device.

18. The terminal device according to claim 17, wherein the processor, when loading and running the at least one computer program stored in the memory, is caused to perform:
receiving the second information from the source network device via a source relay terminal device, wherein the second information comprises an identifier of the target relay terminal device.

19. The terminal device according to claim 18, wherein the processor, when loading and running the at least one computer program stored in the memory, is caused to perform:
transmitting a measurement report to the source network device via the source relay terminal device.

20. The terminal device according to claim 19, wherein the measurement report comprises at least one of:
an identifier of a candidate relay terminal device;
a signal strength of a candidate relay terminal device;
an identifier of a candidate cell to which a candidate relay terminal device belongs; or
a signal strength of a candidate cell to which a candidate relay terminal device belongs.
